(19) United States
(12) Patent Application Publication
(10) Pub. No.: US 2026/0058884 A1
(43) Pub. Date: Feb. 26, 2026

(54) ARTIFICIAL INTELLIGENCE (AI) TASK PROCESSING METHOD AND APPARATUS

(71) Applicant: BEIJING XIAOMI MOBILE SOFTWARE CO., LTD., Beijing (CN)

(72) Inventors: Dong CHEN, Beijing (CN); Yuze SUN, Beijing (CN)

(73) Assignee: BEIJING XIAOMI MOBILE SOFTWARE CO., LTD., Beijing (CN)

(21) Appl. No.: 19/108,601

(22) PCT Filed: Sep. 9, 2022
(86) PCT No.: PCT/CN2022/118270

§ 371 Date: Mar. 4, 2025

(51) Int. Cl. H04L 41/16

(52) U.S. Cl. CPC H04L 41/16

(57) ABSTRACT

An artificial intelligence (AI) task processing method is executed by a first AI network element. The method includes: receiving an AI service request message sent by an AMF network element, the AI service request message being used to indicate an AI service to be provided; determining at least one AI task according to the AI service request message; determining a first processing parameter of the first AI network element and a second processing parameter of a second AI network element; according to the at least one AI task, the first processing parameter and the second processing parameter, determining at least one of a first task executed by the first AI network element in the AI task or a second task executed by the second AI network element.

### CROSS-REFERENCE TO RELATED APPLICATION

This application is the U.S. National Stage Application of International Application No. PCT/CN2022/118270, filed on Sep. 9, 2022, the entire disclosure of which is incorporated herein by reference.

### FIELD

The present disclosure relates to the field of communication technology, in particular to an Artificial Intelligence (AI) task processing method and an AI task processing apparatus.

### BACKGROUND

In the related art, many automation measures have already been adopted in a network to improve operation and maintenance efficiency. Among these measures, AI may be used to help the network to achieve autonomy at a higher level, so it has become a core technology for future communication.

However, the AI technology is applied to the communication network relatively late, and an AI function in the network is simply added to a network process, i.e., it is an add-on application. Along with an increase in the AI functions, an overhead of the network for achieving different AI functions is very large, and there is an urgent need to solve this problem.

### SUMMARY

In a first aspect, the present disclosure provides an AI task processing method, executed by a first AI network element, including: receiving an AI service request message sent by an access and mobility management function (AMF) network element, wherein the AI service request message is used to indicate an AI service to be provided; determining at least one AI task based on the AI service request message; determining a first processing parameter of the first AI network element and a second processing parameter of a second AI network element; and determining at least one of a first task to be executed by the first AI network element or a second task to be executed by the second AI network element in the at least one AI task based on the at least one AI task, the first processing parameter and the second processing parameter.

In a second aspect, the present disclosure provides another AI task processing method, executed by an AMF network element, including: receiving an AI service establishment request message sent by a terminal device, wherein the AI service establishment request message is used to indicate an AI service required by the terminal device; and sending an AI service request message to a first AI network element, wherein the AI service request message is used to indicate the AI service to be provided, and the first AI network element determines at least one AI task, a first processing parameter of the first AI network element and a second processing parameter of a second AI network element based on the AI service request message, and determines at least one of a first task to be executed by the first AI network element or a second task to be executed by the second AI network element in the at least one AI task based on the at least one AI task, the first processing parameter and the second processing parameter.

In a third aspect, the present disclosure provides yet another AI task processing method, executed by a second AI network element, including: receiving a second task sent by a first AI network element, wherein the second task is determined by the first AI network element to be executed by the second AI network element based on at least one AI task, a determined first processing parameter of the first AI network element and a determined second processing parameter of the second AI network element, and sent by the first AI network element to the second AI network element, the at least one AI task is determined by the first AI network element based on an AI service request message sent by an AMF network element, and the AI service request message is used to indicate an AI service to be provided.

### BRIEF DESCRIPTION OF THE DRAWINGS

In order to illustrate the technical solutions of the embodiments of the present disclosure or the background in a clearer manner, the drawings desired for the embodiments of the present disclosure or the background will be described hereinafter briefly.

FIG. 1 is a schematic view showing architecture of a communication system according to an embodiment of the present disclosure;

FIG. 2 is a schematic view showing system architecture according to an embodiment of the present disclosure;

FIG. 3 is a flow chart of an AI task processing method according to an embodiment of the present disclosure;

FIG. 4 is another flow chart of the AI task processing method according to an embodiment of the present disclosure;

FIG. 5 is yet another flow chart of the AI task processing method according to an embodiment of the present disclosure;

FIG. 6 is still yet another flow chart of the AI task processing method according to an embodiment of the present disclosure;

FIG. 7 is still yet another flow chart of the AI task processing method according to an embodiment of the present disclosure;

FIG. 8 is still yet another flow chart of the AI task processing method according to an embodiment of the present disclosure;

FIG. 9 is still yet another flow chart of the AI task processing method according to an embodiment of the present disclosure;

FIG. 10 is still yet another flow chart of the AI task processing method according to an embodiment of the present disclosure;

FIG. 11 is still yet another flow chart of the AI task processing method according to an embodiment of the present disclosure;

FIG. 12 is still yet another flow chart of the AI task processing method according to an embodiment of the present disclosure;

FIG. 13 is still yet another flow chart of the AI task processing method according to an embodiment of the present disclosure;

FIG. 14 is a block diagram showing a communication apparatus according to an embodiment of the present disclosure;

FIG. 15 is another block diagram showing the communication apparatus according to an embodiment of the present disclosure;

FIG. 16 is yet another block diagram showing the communication apparatus according to an embodiment of the present disclosure; and

FIG. 17 is a block diagram of a chip according to an embodiment of the present disclosure.

### DETAILED DESCRIPTION

In order to understand an AI task processing method and an AI task processing apparatus in the embodiments of the present disclosure in a better manner, an applicable communication system in the embodiments of the present disclosure will be described hereinafter at first.

The present disclosure will be described hereinafter in details in conjunction with illustrative embodiments, and examples thereof are shown in the drawings. Unless otherwise specified, identical numerals in different drawings represent identical or similar elements. The implementations in the following description do not include all implementations consistent with the embodiments of the present disclosure, and in contrast, they are merely examples of devices and methods consistent with some aspects of the embodiments of the present disclosure as specified in the appended claims.

The terms used in embodiments of the present disclosure are for illustrative purposes only, but do not intend to limit the present disclosure. Such a singular form as “one” or “the” used in the embodiments of the present disclosure and the appended claims also intends to include a plural form, unless otherwise defined. It should be appreciated that, the expression “and/or” used in the context is meant to include any combination, or all possible combinations, of one or more associated items.

It should be appreciated that, although such expressions as “first”, “second” and “third” are used to describe various information, the information are not limited by these expressions. These expressions are merely used to differentiate the information of a same type from each other. For example, without departing from the scope of the present disclosure, first information may also be called as second information, and similarly second information may also be called as first information. Depending on the context, such a word as “if” may be construed as “in a case that . . . ”, “in the case that . . . ” or “in response to determining that . . . ”.

It should be appreciated that, information (including, but not limited to, user device information and user's personal information), data (including, but not limited to, data for analysis, stored data and presented data) and signals involved in the present disclosure are all authorized by a user or authorized fully by the parties, and the collection, use and processing of relevant data need to comply with relevant laws, regulations and standards of relevant countries and regions.

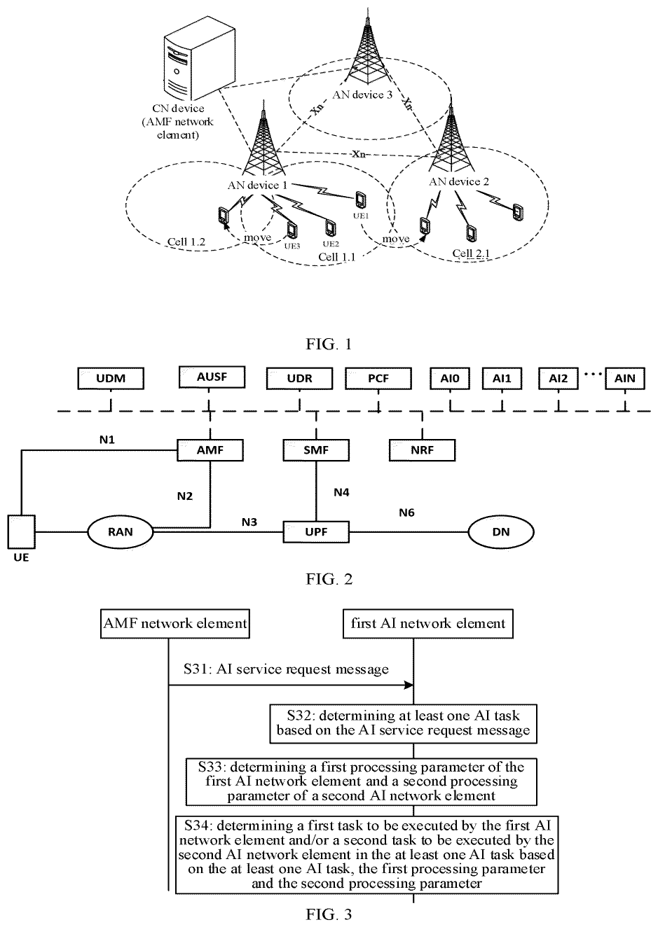

Referring to FIG. 1 which is a schematic view showing a communication system according to an embodiment of the present disclosure, the communication system includes, but not limited to, a (radio) access network ((R)AN) device, a terminal device and a core network device. The (R)AN devices communicate with each other in a wired or wireless manner, e.g., via an Xn interface in FIG. 1. The (R)AN device covers one or more cells, e.g., a (R)AN device 1 covers a cell 1.1 and a cell 1.2, and a (R)AN device 2 covers a cell 2.1. The terminal device resides in the (R)AN device in one cell, and it is in a connected state. Further, the terminal device is switched from the connected state to an inactive state, i.e., a nonconnected state, via a radio resource control (RRC) release process. The terminal device in the nonconnected state may reside in an original cell, and perform uplink transmission and/or downlink transmission with the (R)AN device in the original cell based on a transmission parameter of the terminal device in the original cell. The terminal device in the nonconnected state may also move to a new cell, and perform uplink transmission and/or downlink transmission with the (R)AN device in the new cell based on a transmission parameter of the terminal device in the new cell.

It should be appreciated that, FIG. 1 is merely an illustrative schematic view, and a quantity of nodes, a quantity of cells and a state of the terminal device in FIG. 1 will not be limited. In addition to the functional nodes in FIG. 1, the communication system may further include the other nodes, e.g., a gateway device and an application server, which will not be particularly defined herein. The (R)AN device communicates with the core network device in a wired or wireless manner, e.g., via a next generation (NG) interface.

The terminal device is an entity at a user side for receiving or sending a signal, e.g., a mobile phone. The terminal device may also be called as terminal, user equipment (UE), mobile station (MS), mobile terminal (MT), etc. The terminal device may be a vehicle having a communication function, a smart vehicle, a mobile phone, a wearable device, a pad, a computer having a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. In the embodiments of the present disclosure, a specific technology adopted by the terminal device and a specific device form thereof will not be particularly defined.

The (R)AN device is used to provide a network access function for an authorized terminal device in a specific region, and use transmission channels with different quality based on a level of the terminal device and a service requirement. For example, the (R)AN device may manage radio resources, provide an access service for the terminal device, and thereby forward control information and/or data information between the terminal device and a core network (CN). The (R)AN device in the embodiments of the present disclosure is a device for providing a wireless communication function for the terminal device, and it may also be called as network device. For example, the (R)AN device includes a next generation node base station (gNB) in a 5th-Generation (5G) system, an evolved node B (eNB) in a long term evolution (LTE), a radio network controller (RNC), a node B (NB), a base station controller (BSC), a base transceiver station (BTS), a home base station (e.g., hone evolved node B or home node B (HNB)), a base band unit (BBU), a transmitting and receiving point (TRP), a transmitting point (TP), a pico, a mobile switching center, or a network device in a future network. It should be appreciated that, a specific type of the (R)AN device will not be particularly defined in the embodiments of the present disclosure. In a system using different radio access technologies, names of the devices having an access network device function may be different.

The core network device includes an AMF and/or a location management function network element. Optionally, the location management function network element includes a location server, and the location server may be implemented as any one of a Location Management Function (LMF), an Enhanced Serving Mobile Location Centre (E-SMLC), a Secure User Plane Location (SUPL), or a SUPL Location Platform (SUPL SLP).

In order to facilitate the understanding of network architecture of the communication system, as shown in FIG. 2 which is a schematic view showing the network architecture according to an embodiment of the present disclosure, the network architecture includes an AMF network element, a UDM network element, an AUSF network element, a UPF network element, a UDR network element, a PCF network element, a NRF network element, an AI0 network element, an AI1 network element, . . . , and an AIN network element.

The access and mobility management function (AMF) network element is mainly used for mobility management and access management, and it is used to achieve the functions in a mobility management entity (MME) function other than session management, e.g., lawful interception and access authorization/authentication. It should be appreciated that, the AMF network function is called as AMF for short. In the embodiments of the present disclosure, the AMF includes an initial AMF, an old AMF and a target AMF. For example, the initial AMF may be understood as an AMF which first processes a UE registration request in current registration, and the initial AMF is selected by the (R)AN device, but the initial AMF does not necessarily serve the UE. The old AMF may be understood as an AMF which serves the UE when the UE is registered with a network previously. The target AMF may be understood as an AMF which serves the UE after the UE performs re-registration.

A session management function (SMF) network element is mainly used for session management, and allocation and management of Internet Protocol (IP) addresses of the UE.

The UPF network element is used for packet routing and forwarding, or the processing of quality of service (QoS) of user plane data. The user plane data is provided to a data network (DN) via the network element.

The DN is used to provide a network for transmitting data, e.g., a network for an operator's service, Internet, or a third-party service network.

The authentication server function (AUSF) network element is mainly used for user authentication.

A network exposure function (NEF) network element is used to safely expose services and capabilities provided by a 3GPP network function to the outside.

The network function (NF) repository function (NRF) network element is used to store a network function entity and descriptive information about a service provided by the network function entity, and support service discovery and network element entity discovery.

The policy control function (PCF) network element is used to guide a unified policy framework of network behaviors, and provide policy rule information for control plane function elements (e.g., AMF and SMF network elements).

The unified data management (UDM) network element is used to process user identification, access authentication, registration or mobility management.

In the network architecture, an N1 interface is an interface between the terminal device and the AMF network element. An N2 interface is an interface between the (R)AN and the AMF network element, and configured to send a non-access stratum (NAS) message. An N3 interface is an interface between the (R)AN and a UPF entity, and configured to transmit user plane data. An N4 interface is an interface between an SMF entity and the UPF entity, and configured to transmit such as identification information about a tunnel connected to the N3 interface, data caching indication information and a downlink data notification message. An N6 interface is an interface between the UPF entity and the DN, and configured to transmit the user plane data.

It should be appreciated that, the terms introduced hereinabove may have different names in different fields or different standards, so the names described hereinabove shall not be construed as limiting the embodiments of the present disclosure. The network functions or functions may be network elements in a hardware device, or software functions on dedicated hardware, or instantiated, virtualized functions on a platform (e.g., a cloud platform).

It should be further appreciated that, the network elements involved in the embodiments of the present disclosure may also be called as functional devices, functions, entities or functional entities, e.g., the AMF network element may also be called as an AMF device, an AMF, or an AMF entity. The name of each functional device will not be particularly defined herein, and it may be replaced with any other name for achieving a same function, which also falls within the scope of the present disclosure. The functional device may be a network element in a hardware device, or a software function on dedicated hardware, or instantiated, virtualized functions on a platform (e.g., a cloud platform).

It should be further appreciated that, the communication system and the network architecture described in the embodiments of the present disclosure are used to describe the technical solutions of the embodiments of the present disclosure in a clearer manner, but shall not be construed as limiting the technical solutions provided in the embodiments of the present disclosure. As is known in the art, along with the evolution of the system architecture as well as the emergence of new service scenarios, the technical solutions are also applicable to similar technical problems.

The AI task processing method and the AI task processing apparatus provided in the embodiments of the present disclosure will be described hereinafter in details in conjunction with the drawings.

In the related art, AI will become one of the core technologies for future communication, and typical 6^{th}-Generation (6G) application scenarios overlap with typical AI application scenarios by more than 80%, i.e., the two are deeply integrated with each other. In addition, a large-scale coverage of a 6G network will provide a ubiquitous carrier space for the AI, so as to solve the problem that there is a lack of carriers and channels for the implementation of the AI technology, thereby to remarkably promote the development and prosperity of the AI industry.

In the related art, many automation measures have been adopted by a network during planning, construction, maintenance and optimization, so as to improve the operation and maintenance efficiency, but the overall autonomous level of the network is not high enough and there is a lot of room to improve. Due to software defined network (SDN) and network functions virtualization (NFV), the network has high flexibility but more complexity. When more factors are taken into consideration for allocating network resources and designing a transmission path and an optimization algorithm, it is also required to take a more intelligent measure. With the AI technology, it is able to improve the autonomous level of the network, reduce the cost and improve the efficiency. The AI technology is applied to a communication network relatively late, so an existing network intelligence application is optimized and rebuilt on conventional network architecture, and it belongs to an add-on application as a whole. Due to the lack of a general AI operating process and a unified technical framework, the AI application scenario of the network is fragmentized, and the development thereof is performed in a chimney-like manner. The AI functions are simply added on an existing network process, and it is difficult to achieve the coordination of the intelligence applications in a cross-domain, cross-layer manner. A network data analytics function (NWDAF) is used to collect data, perform analysis and provide an analysis result to the other network functions, but it does not classify data analysis into different types, classify the data with respect to a specific AI algorithm, and classify AI tasks based on a task-level computational workload. Hence, along with an increase in the AI functions, an overhead of the network for different AI functions is very large, and there is an urgent need to solve this problem.

Based on the above, in the embodiments of the present disclosure, the AI network functions are refined and a parent-child relationship is introduced. AI network elements are divided based on a specific algorithm and a task type, so that they include an AI management-level network element (AI0) and several secondary AIi network elements at an equal level (AI1\AI2\ . . . \AIN). AI0 takes charge of signaling analysis, resource allocation and distribution deployment for AI services, and it closely cooperates with the other NFs, e.g., UDM and AMF, to perform analysis based on input information at a UE end, determine a specific AI task type, and select a corresponding secondary AIi network element to provide a service, including classification, regression, clustering, etc. In addition, AI0 is provided with strong computing and storing resources, so it can process a compute-intensive task. An entire service process of the AI network function is achieved via a combination of AI0 and several secondary AIi network elements.

In this process, the issuing and scheduling of each task is important. In the embodiments of the present disclosure, the AI0 network element determines processing parameters of the AI0 network element and the AIi network elements, determines a task offloading policy, and determines an AI task to be executed by the AI0 network element and/or an AI task to be executed by the AIi network element, so it is able to reduce the overhead. In addition, the corresponding resource allocation is performed based on the task offloading policy, so as to allocate the resources appropriately, thereby to execute the AI service efficiently and flexibly.

In addition, for ease of understanding, the followings will be described at first.

Firstly, in the embodiments of the present disclosure, the expression “used to indicate” includes “used to directly indicate” and “used to indirectly indicate”. In a case that certain information is used to indicate A, it means that the information is used to directly indicate A or indirectly indicate A, but it does not mean that the information certainly carries A.

Information indicated by the information is called as to-be-indicated information, and during the implementation, the to-be-indicated information may be indicated in various ways, which include, but not limited to, the followings. The to-be-indicated information may be indicated directly, e.g., the to-be-indicated information itself or an index of the to-be-indicated information may be indicated directly. Also, the to-be-indicated information may be indicated indirectly via indicating the other information, and the other information is associated with the to-be-indicated information. Further, only a part of the to-be-indicated information is indicated, and the other part of the to-be-indicated information is known or pre-agreed. For example, specific information is indicated by means of a pre-agreed order of pieces of information (e.g., specified in a protocol), so as to reduce the indication overhead to some extent.

The to-be-indicated information may be sent as a whole, or sent separately in the form of a plurality of pieces of information, and sending periods and/or sending occasions of the plurality of pieces of information may be the same or different. A specific sending method will not be particularly defined herein. The sending periods and/or sending occasions of the plurality of pieces of information may be predefined, e.g., predefined based on the protocol.

Secondly, such words as “first” and “second” are only used for ease of description, but shall not be used to limit the scope of the embodiments of the present disclosure. For example, they are used to differentiate the information or AI network elements from each other.

Thirdly, the terminal device has already completed an initial registration process, and been connected to the network.

Fourthly, the first AI network element has already completed the registration at the NRF, and it can normally access and operate in the core network architecture.

Fifthly, the core network has already authenticated each first AI network element and at least one second AI network element, so as to ensure the safe access thereof.

Sixthly, the first AI network element and the at least one second AI network element trust each other, and true communication information is transferred therebetween. The second AI network element may be a secondary network function, e.g., AI1, AI2, . . . , or AIN, in FIG. 2, and it is parallel to the other NF, e.g., PCF or UDR.

Seventhly, communication quality between different second AI network elements and the first AI network element (e.g., channel quality or bandwidth condition) may be the same or different.

Eighthly, each time the first AI network element allocates a task, the first AI network element and/or the second AI network elements complete the task jointly, and each network element takes charge of a subtask. For each task, a part of the second AI network elements may participate in the computation and communication.

Ninthly, the term “protocol” involved in the embodiments of the present disclosure refers to a standard protocol in the communication field, e.g., a LTE protocol, a NR protocol or a relevant protocol in a future communication system, which will not be particularly defined herein.

Tenthly, a plurality of implementation modes has been listed to clearly describe the technical solutions in the embodiments of the present disclosure. Of course, it should be appreciated that, the embodiments of the present disclosure may be performed individually, or performed in combination with the method in the other embodiments, or performed, individually or after the combination with the method, together with some other methods known in the related art, which will not be particularly defined herein.

Referring to FIG. 3 which is a flow chart of an AI task processing method according to an embodiment of the present disclosure, the method includes, but not limited to, the following steps.

In an embodiment of the present disclosure, an AMF network element receives, via an access network device, an AI service establishment request message sent by a terminal device (e.g., transparent transmission), and the AI service establishment request message is used to indicate an AI service required by the terminal device. Then, the AMF network element determines the AI service required by the terminal device based on the AI service establishment request message.

The AI service establishment request message includes an AI service type, an AI service Identifier (ID), etc.

In a case that the AMF network element determines the AI service required by the terminal device, S31 may be performed.

S31: an AI service request message is sent to a first AI network element, and the AI service request message is used to indicate an AI service to be provided.

In an embodiment of the present disclosure, the AMF network element sends the AI service request message (CreateAlOContext_Request) to the first AI network element, so as to indicate the AI service to be provided.

The AI service request message includes an AI service type, an AI service ID, user information, etc.

In an embodiment of the present disclosure, the first AI network element is a management-level network element, and it takes charge of signaling analysis, resource allocation and distribution deployment for the AI service. Upon the receipt of the AI service request message sent by the AMF network element, the first AI network element performs S32 to S34 based on the AI service request message.

S32: at least one AI task is determined based on the AI service request message.

Upon the receipt of the AI service request message sent by the AMF, the first AI network element determines the AI service to be provided. The first AI network element may analyze the AI service, and determine the at least one AI task to be provided.

It should be appreciated that, the first AI network element may analyze the AI service, determine an AI algorithm to be provided, perform task splitting based on the AI algorithm, and determine the at least one AI task.

Illustratively, based on the AI service request message, at least one classification AI task, at least one regression AI task or at least one clustering AI task is determined, or one classification AI task and one regression AI task are determined.

It should be appreciated that, the above examples are for illustrative purposes only, but shall not be construed as limiting the embodiments of the present disclosure. The determined AI task may also be of any type other than those mentioned hereinabove. The AI task may also be determined in any other ways. For example, the first AI network element determines a specific way for determining the AI task based on an AI model function deployed locally in the first AI network element and an AI model function deployed locally in each second AI network element, i.e., the way for determining the AI task may be set in advance.

S33: a first processing parameter of the first AI network element and a second processing parameter of the second AI network element are determined.

In an embodiment of the present disclosure, the first AI network element may determine the first processing parameter by itself. The first AI network element may determine the second processing parameter of the second AI network element based on an agreement in a protocol, or based on an indication from a network side device, or based on an indication from the second AI network element.

Illustratively, in a case that the first AI network element determines the second processing parameter of the second AI network element based on the indication from the second AI network element, the second AI network element reports indication information to the first AI network element, and the indication information is used to indicate the second processing parameter of the second AI network element, so that the first AI network element determines the second processing parameter of the second AI network element.

In some possible embodiments of the present disclosure, the first processing parameter includes a first task type supported to be processed by the first AI network element, and the second processing parameter includes a second task type supported to be processed by the second AI network element.

In some embodiments of the present disclosure, the first processing parameter includes a computing rate at which the AI task is processed by the first AI network element, and the second processing parameter includes a computing rate at which the AI task is processed by the first AI network element. In a case that there is a plurality of AI tasks, the first processing parameter includes a computing rate at which each AI task is processed by the first AI network element, and the second processing parameter includes a computing rate at which each AI task is processed by the second AI network element.

In some possible embodiments of the present disclosure, the first processing parameter includes a specific parameter for determining whether or not to execute, by the first AI network element, the AI task, and the second processing parameter includes a specific parameter for determining whether or not to execute, by the second AI network element, the AI task.

S34: a first task to be executed by the first AI network element and/or a second task to be executed by the second AI network element in the at least one AI task are determined based on the at least one AI task, the first processing parameter and the second processing parameter.

In an embodiment of the present disclosure, in a case that the first AI network element determines the at least one AI task, the first processing parameter of the first AI network element and the second processing parameter of the second AI network element based on the AI service request message, the first AI network element determines the first task to be executed by the first AI network element and/or the second task to be executed by the second AI network element in the at least one of AI task based on the at least one AI task, the first processing parameter and the second processing parameter.

Illustratively, in a case that the first processing parameter includes the first task type supported to be processed by the first AI network element and the second processing parameter includes the second task type supported to be processed by the second AI network element, the first AI network element determines a target task type of the at least one AI task, and in a case that the first task type supported to be processed by the first AI network element is the same as the target task type, determines that the AI task is to be executed by the first AI network element. In a case that the first task type supported to be processed by the first AI network element is different from the target task type, the first AI network element determines that the AI task is not to be executed by the first AI network element. Alternatively, in a case that the second task type supported to be processed by the second AI network element is the same as the target task type, the first AI network element determines that the AI task is to be executed by the second AI network element, and in a case that the second task type supported to be processed by the second AI network element is different from the target task type, the first AI network element determines that the AI task is not to be executed by the second AI network element.

It should be appreciated that, the above examples are for illustrative purposes only, and the first processing parameter and the second processing parameter may also be any parameters other than those mentioned hereinabove or any other parameters including those mentioned hereinabove, which will not be particularly defined herein.

According to the embodiments of the present disclosure, the first AI network element receives the AI service request message sent by the AMF network element, and the AI service request message is used to indicate the AI service to be provided. The first AI network element determines the at least one AI task based on the AI service request message, determines the first processing parameter of the first AI network element and the second processing parameter of the second AI network element, and determines the first task to be executed by the first AI network element and/or the second task to be executed by the second AI network element in the at least one task based on the at least one AI task, the first processing parameter and the second processing parameter. In this way, the first AI network element determines the first task to be executed by the first AI network element and/or the second task to be executed by the second AI network element in the at least one AI task, so it is able to schedule the AI task in a classified manner, and allocate resources based on the scheduling, thereby to reduce an overhead, allocate the resources appropriately, and perform the AI service more efficiently and flexibly.

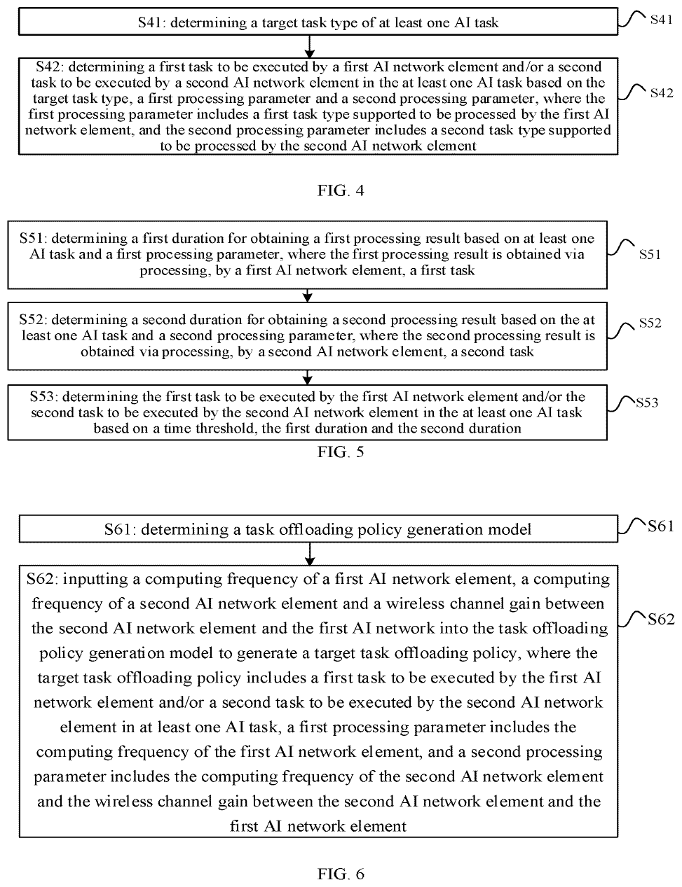

In some embodiments of the present disclosure, FIG. 4 shows a method for determining, by the first AI network element, the first task to be executed by the first AI network element and/or the second task to be executed by the second AI network element in the at least one AI task based on the at least one AI task, the first processing parameter and the second processing parameter, and this method is executed by the first AI network element and includes, but not limited to, the following steps.

S41: a target task type of the at least one AI task is determined.

S42: the first task to be executed by the first AI network element and/or the second task to be executed by the second AI network element in the at least one AI task are determined based on the target task type, the first processing parameter and the second processing parameter. The first processing parameter includes a first task type supported to be processed by the first AI network element, and the second processing parameter includes a second task type supported to be processed by the second AI network element.

In an embodiment of the present disclosure, the first AI network element determines the target task type of the AI task, e.g., a classification task or a regression task.

In an embodiment of the present disclosure, in a case that the first AI network element determines the first processing parameter of the first AI network element, the first AI network element determines the first task type supported to be processed by the first AI network element, e.g., the first task type supported to be processed by an AI service function locally stored in the first AI network element. It should be appreciated that, the first AI network element may support to process various task types, and the first task type may include various task types.

In an embodiment of the present disclosure, in a case that the first AI network element determines the second processing parameter of the second AI network element, the first AI network element determines the second task type supported to be processed by the second AI network element, e.g., the second task type supported to be processed by an AI service function locally stored in the second AI network element. It should be appreciated that, the second AI network element may support to process various task types, and the second task type may include various task types.

In a possible embodiment of the present disclosure, the first AI network element determines the target task type of the AI task, and the first task type supported to be processed by the first AI network element. In a case that the first task type supported to be processed by the first AI network element is the same as the target task type, the first AI network element determines that the AI task is to be executed by the first AI network element, and in a case that the first task type supported to be processed by the first AI network element is different from the target task type, the first AI network element determines that the AI task is not to be executed by the first AI network element.

In a possible embodiment of the present disclosure, the first AI network element determines the target task type of the AI task, and the second task type supported to be processed by the second AI network element. In a case that the second task type supported to be processed by the second AI network element is the same as the target task type, the first AI network element determines that the AI task is to be executed by the second AI network element, and in a case that the second task type supported to be processed by the second AI network element is different from the target task type, the first AI network element determines that the AI task is not to be executed by the second AI network element.

Illustratively, the first AI network element determines that the target task type of a k^{th} task in the at least one AI task is a classification task, the first task type supported to be processed by the first AI network element includes the classification task, and the second task type supported to be processed by the second AI network element includes a regression task. Based on this, the first AI network element determines that the k^{th} task in the at least one AI task is to be executed by the first AI network element, where k is a positive integer.

Illustratively, the first AI network element determines that the target task type of the k^{th} task in the at least one AI task is a classification task, the first task type supported to be processed by the first AI network element includes a regression task, and the second task type supported to be processed by the second AI network element includes the classification task. Based on this, the first AI network element determines that the k^{th} task in the at least one AI task is to be executed by the second AI network element, where k is a positive integer.

Illustratively, the first AI network element determines that the target task type of the k^{th} task in the at least one AI task is a classification task, the first task type supported to be processed by the first AI network element includes the classification task, and the second task type supported to be processed by the second AI network element includes the classification task. Based on this, the first AI network element determines that the k^{th} task in the at least one AI task is to be executed by the first AI network element and the second AI network element simultaneously, where k is a positive integer.

According to the embodiments of the present disclosure, the first AI network element determines the target task type of the AI task, an determines the first task to be executed by the first AI network element and/or the second task to be executed by the second AI in the at least one AI task based on the target task type, the first processing parameter and the second processing parameter. The first processing parameter includes the first task type supported to be processed by the first AI network element, and the second processing parameter includes the second task type supported to be processed by the second AI network element. In this way, the first AI network element determines the first task to be executed by the first AI network element and/or the second task to be executed by the second AI network element in the at least one AI task, so it is able to schedule the AI task in a classified manner, and allocate resources based on the scheduling, thereby to reduce the overhead, allocate the resources appropriately, and perform the AI service more efficiently and flexibly.

In some embodiments of the present disclosure, the AI service request message is further used to indicate a time threshold for obtaining a processing result. FIG. 5 shows a method for determining, by the first AI network element, the first task to be executed by the first AI network element and/or the second task to be executed by the second AI network element in the at least one AI task based on the at least one AI task, the first processing parameter and the second processing parameter, and this method is executed by the first AI network element and includes, but not limited to, the following steps.

S51: a first duration for obtaining a first processing result is determined based on the at least one AI task and the first processing parameter, and the first processing result is obtained via processing, by the first AI network element, the first task.

In an embodiment of the present disclosure, the first AI network element determines the first duration for obtaining the first processing result based on the at least one AI task and the first processing parameter, and the first processing result is obtained via processing, by the first AI network element, the first task.

Illustratively, the first processing parameter includes a computing rate at which the AI task is processed by the first AI network element. The first AI network element may determine a data volume of the first task, so as to determine the first duration for obtaining the first processing result based on the computing rate of the first processing parameter and the data volume of the first task.

S52: a second duration for obtaining a second processing result is obtained based on the at least one AI task and the second processing parameter, and the second processing result is obtained via processing, by the second AI network element, the second task.

In an embodiment of the present disclosure, the first AI network element determines the second duration for obtaining the second processing result based on the at least one AI task and the second processing parameter, and the second processing result is obtained via processing, by the second AI network element, the second task.

Illustratively, the second processing parameter includes a computing rate at which the second task is processed by the second AI network element, an uploading rate at which the processing result of the second task is uploaded by the second AI network element, and a waiting delay. The first AI network element determines a data volume of the second task, so as to determine the second duration for obtaining the second processing result based on the computing rate at which the second task is processed by the second AI network element, the uploading rate at which the processing result of the second task is uploaded by the second AI network element, the waiting relay and the data volume of the second task.

S53: the first task to be executed by the first AI network element and/or the second task to be executed by the second AI network element in the at least one AI task are determined based on the time threshold, the first duration and the second duration.

In an embodiment of the present disclosure, the AI service request message is further used to indicate the time threshold for obtaining the processing result. For example, the time threshold is 5 minutes, 1 minute, etc.

In a possible embodiment of the present disclosure, in a case that the first duration is smaller than or equal to the time threshold, the first AI network element determines that the AI task is to be executed by the first AI network element, and in a case that the first duration is greater than the time threshold, the first AI network element determines that the AI task is not to be executed by the first AI network element.

In a possible embodiment of the present disclosure, in a case that the second duration is smaller than or equal to the time threshold, the first AI network element determines that the AI task is to be executed by the second AI network element, and in a case that the second duration is greater than the time threshold, the first AI network element determines that the AI task is not to be executed by the second AI network element.

Illustratively, the time threshold is 5 minutes, and the first AI network element determines that the first duration for obtaining the first processing result of a k^{th} task in the at least one AI task processed by the first AI network element is 4 minutes which is smaller than the time threshold, so the first AI network element may determine that the k^{th} task in the at least one AI task is to be executed by the first AI network element, where k is a positive integer.

Illustratively, the time threshold is 5 minutes, and the first AI network element determines that the first duration for obtaining the first processing result of the k^{th} task in the at least one AI task processed by the first AI network element is 6 minutes which is greater than the time threshold, so the first AI network element may determine that the k^{th} task in the at least one AI task is not to be executed by the first AI network element, where k is a positive integer.

Illustratively, the time threshold is 5 minutes, and the first AI network element determines that the second duration for obtaining the second processing result of the k^{th} task in the at least one AI task processed by the second AI network element is 3 minutes which is smaller than the time threshold, so the first AI network element may determine that the k^{th} task in the at least one AI task is to be executed by the second AI network element, where k is a positive integer.

Illustratively, the time threshold is 5 minutes, and the first AI network element determines that the second duration for obtaining the second processing result of the k^{th} task in the at least one AI task processed by the second AI network element is 6 minutes which is greater than the time threshold, so the first AI network element may determine that the k^{th} task in the at least one AI task is not to be executed by the second AI network element, where k is a positive integer.

It should be appreciated that, the above examples are for illustrative purposes only, and the time threshold, the first duration and the second duration may be of any other values, which will not be particularly defined herein.

In some embodiments of the present disclosure, the determining, by the first AI network element, the first processing parameter of the first AI network element includes determining a computing rate r_{0,k} at which the k^{th} AI task is processed by the first AI network element.

$${r}_{0 , k} = \frac{{f}_{0} {t}_{0 , k}}{M {t}_{0 , k}} = \frac{{f}_{0}}{M} ,$$

where f₀ represents a computing frequency of the first AI network element, and M represents a central processing unit (CPU) cycle number for processing, by the first AI network element, 1-bit task data.

In some embodiments of the present disclosure, the determining, by the first AI network element, the second processing parameter of the second AI network element includes determining a computing rate

$${r}_{i , k}^{comp}$$

at which the k^{th} AI task is processed by an i^{th} second AI network element, an uploading rate

$${r}_{i , k}^{up}$$

at which a processing result of the k^{th} AI task is uploaded, and a waiting delay T_{i,k}.

$${r}_{i , k}^{comp} = \frac{{f}_{i} {t}_{i , k}}{{M}_{i} {t}_{i , k}} = \frac{{f}_{i}}{{M}_{i}} , {r}_{i , k}^{up} = B log ( 1 + \frac{{Ph}_{i}^{2}}{{N}_{0}} ) ,$$

where B represents a bandwidth, P represents power, N₀ represents a gaussian white noise, hᵢ represents a wireless channel gain between the i^{th} second AI network element and the first AI network element, fᵢ represents a computing frequency of the i^{th} second AI network element, and Mᵢ represents a CPU cycle number for processing, by the i^{th} second AI network element, 1-bit task data.

In some embodiments of the present disclosure, the determining, by the first AI network element, the first task to be executed by the first AI network element and/or the second task to be executed by the second AI network element based on the time threshold, the first duration and the second duration includes: in response to meeting t_{0,k}≤Tₘₐₓ, determining that a k^{th} AI task is to be executed by the first AI network element; and/or in response to meeting

$${t}_{i , k}^{comp} + {t}_{i , k}^{up} \leq {T}_{max} ,$$

determining that the k^{th} AI task is to be executed by an i^{th} second AI network element,
wherein Tₘₐₓ represents the time threshold;
t_{0,k} represents the first duration for processing, by the first AI network element, the k^{th} AI task,

$${t}_{0 , k} = \frac{{D}_{k}}{{r}_{0 , k}} ,$$

Dₖ represents a data volume of the k^{th} AI task, and r_{0,k} represents a computing rate at which the k^{th} AI task is processed by the first AI network element;

$${t}_{i , k}^{comp} + {t}_{i , k}^{up}$$

represents the second duration for processing, by the i^{th} second AI network element, the k^{th} AI task;

$${t}_{i , k}^{comp}$$

represents a computing time for processing, by the i^{th} second AI network element, the k^{th} AI task;

$${t}_{i , k}^{comp} = {t}_{i , k} + {T}_{i , k} , {t}_{i , k} = \frac{{D}_{k}}{{r}_{i , k}^{comp}} , {r}_{i , k}^{comp}$$

represents a computing rate at which the k^{th} AI task is processed by the i^{th} second AI network element, and T_{i,k} represents a waiting delay;

$${t}_{i , k}^{up}$$

represents an uploading time for uploading, by the i^{th} second AI network element, a processing result of the k^{th} AI task; and

$${t}_{i , k}^{up} = \frac{{D}_{k}}{{r}_{i , k}^{up}} , and {r}_{i , k}^{up}$$

represents an uploading rate at which the processing result of the k^{th} AI task is uploaded by the i^{th} second AI network element,
where i and k are both integers.

According to the embodiment of the present disclosure, the first AI network element determines the first duration for obtaining the first processing result based on the at least one AI task and the first processing parameter, and the first processing result is obtained via processing, by the first AI network element, the first task. The first AI network element determines the second duration for obtaining the second processing result based on the at least one AI task and the second processing parameter, and the second processing result is obtained via processing, by the second AI network element, the second task. The first AI network element determines the first task to be executed by the first AI network element and/or the second task to be executed by the second AI network element in the at least one AI task based on the time threshold, the first duration and the second duration. In this way, the first AI network element determines the first task to be executed by the first AI network element and/or the second task to be executed by the second AI network element in the at least one AI task, so it is able to schedule the AI tasks in a classified manner, and allocate resources based on the scheduling, thereby to reduce the overhead, allocate the resources appropriately, and perform the AI service more efficiently and flexibly.

In some embodiments of the present disclosure, FIG. 6 shows a method for determining, by the first AI network element, the first task to be executed by the first AI network element and/or the second task to be executed by the second AI network element in the at least one AI task based on the at least one AI task, the first processing parameter and the second processing parameter, and this method is executed by the first AI network element and includes, but not limited to, the following steps.

S61: a task offloading policy generation model is determined.

S62: the computing frequency of the first AI network element, the computing frequency of the second AI network element and the wireless channel gain between the second AI network element and the first AI network are inputted into the task offloading policy generation model to generate a target task offloading policy. The target task offloading policy includes the first task to be executed by the first AI network element and/or the second task to be executed by the second AI network element in the at least one AI task, the first processing parameter includes the computing frequency of the first AI network element, and the second processing parameter includes the computing frequency of the second AI network element and the wireless channel gain between the second AI network element and the first AI network element.

In an embodiment of the present disclosure, in a case that the first AI network element determines the first task to be executed by the first AI network element and/or the second task to be executed by the second AI network element in the at least one AI task based on the at least one AI task, the first processing parameter and the second processing parameter, the first AI network element may determine the task offloading policy generation model in advance, and input the computing frequency of the first AI network element, the computing frequency of the second AI network element and the wireless channel gain between the second AI network element and the first AI network element into the task offloading policy generation model, so as to generate the target task offloading policy.

The target task offloading policy includes the first task to be executed by the first AI network element and/or the second task to be executed by the second AI network element in the at least one AI task, the first processing parameter includes the computing frequency of the first AI network element, and the second processing parameter includes the computing frequency of the second AI network element and the wireless channel gain between the second AI network element and the first AI network element.

According to the embodiments of the present disclosure, the first AI network element determines the task offloading policy generation model, and inputs the computing frequency of the first AI network element, the computing frequency of the second AI network element and the wireless channel gain between the second AI network element and the first AI network element into the task offloading policy generation model, so as to generate the target task offloading policy. The target task offloading policy includes the first task to be executed by the first AI network element and/or the second task to be executed by the second AI network element in the at least one AI task, the first processing parameter includes the computing frequency of the first AI network element, and the second processing parameter includes the computing frequency of the second AI network element and the wireless channel gain between the second AI network element and the first AI network element. In this way, the first AI network element determines the first task to be executed by the first AI network element and/or the second task to be executed by the second AI network element in the at least one AI task, so it is able to schedule the AI tasks in a classified manner, and allocate resources based on the scheduling, thereby to reduce the overhead, allocate the resources appropriately, and perform the AI service more efficiently and flexibly.

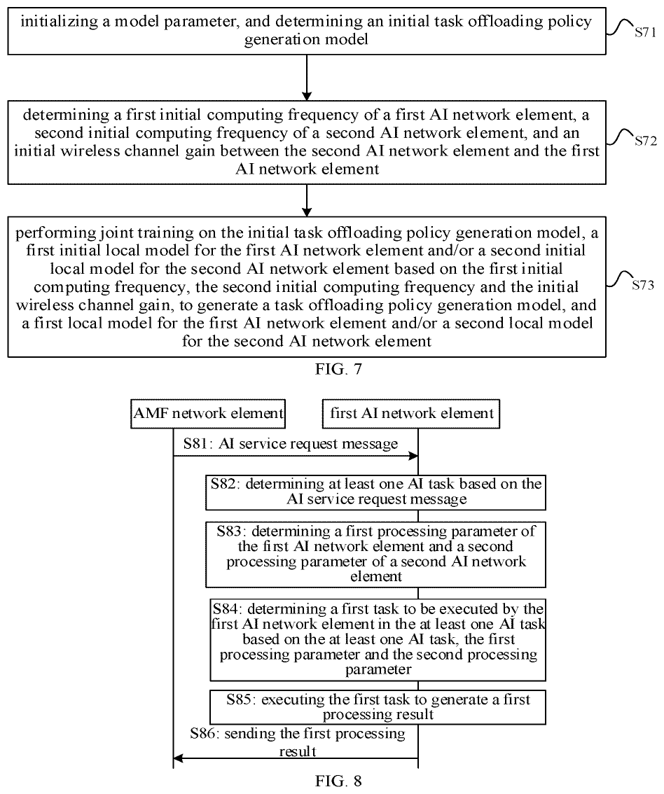

In some embodiments of the present disclosure, FIG. 7 shows a method for determining, by the first AI network element, the task offloading policy generation model, and this method is executed by the first AI network element and includes, but not limited to, the following steps.

S71: a model parameter is initialized, and an initial task offloading policy generation model is determined.

In an embodiment of the present disclosure, a deep reinforcement learning (DRL)-based initial task offloading policy generation model may use a deep neural network (DNN) model. Model parameters of the DNN model, e.g., a quantity of layers and a quantity of neurons, are initialized.

Of course, the initial task offloading policy generation model may also use the other model, and in a case that the first AI network element can determine the task offloading policy generation model, the initial task offloading policy generation model may be set randomly, which will not be particularly defined herein.

S72: a first initial computing frequency of the first AI network element, a second initial computing frequency of the second AI network element, and an initial wireless channel gain between the second AI network element and the first AI network element are determined.

In an embodiment of the present disclosure, the first AI network element determines the first initial computing frequency of the first AI network element by itself. The first AI network element may determine the second initial computing frequency of the second AI network element based on an agreement in a protocol, or based on an indication from a network side, or based on an indication from the second AI network element, which will not be particularly defined herein.

The first AI network element determines the initial wireless channel gain between the second AI network element and the first AI network element based on an agreement in a protocol, or based on an indication from the network side, or based on an indication from the second AI network element, which will not be particularly defined herein.

S73: joint training is performed on the initial task offloading policy generation model, a first initial local model for the first AI network element and/or a second initial local model for the second AI network element based on the first initial computing frequency, the second initial computing frequency and the initial wireless channel gain, to generate the task offloading policy generation model and a first local model for the first AI network element and/or a second local model for the second AI network element.

In an embodiment of the present disclosure, in a case that the first AI network element determines the first initial computing frequency of the first AI network element, the second initial computing frequency of the second AI network element, and the initial wireless channel gain between the second AI network element and the first AI network element, the first AI network element performs the joint training on the initial task offloading policy generation model, and the first initial local model for the first AI network element and/or the second initial local model for the second AI network element based on the first initial computing frequency, the second initial computing frequency and the initial wireless channel gain, to generate the task offloading policy generation model and the first local model for the first AI network element and/or the second local model for the second AI network element.

In some embodiments of the present disclosure, a method for performing, by the first AI network element, the initial task offloading policy generation model, the first initial local model for the first AI network element and/or the second initial local model for the second AI network element based on the first initial computing frequency, the second initial computing frequency and the initial wireless channel gain includes, but not limited to, the following steps.

Step 1: the first AI network element determines iteration epochs T, where T is a positive integer.

Step 2: the first AI network element determines that input model data for a first epoch includes the first initial computing frequency, the second initial computing frequency and the initial wireless channel gain.

Step 3: the first AI network element determines that input model data for a t^{th} epoch includes an updated computing frequency of the first AI network element and/or an updated computing frequency of the second AI network element for a (t−1)^{th} epoch and the initial wireless channel gain which are determined after the first initial local model for the first AI network element and/or the second initial local model for the second AI network element are updated based on input model data for the (t−1)^{th} epoch, where 2≤t≤T.

Step 4: the first AI network element sequentially performs joint training on the initial task offloading policy generation model, the first initial local model for the first AI network element and/or the second initial local model for the second AI network element based on input model data for each epoch.

Step 5: the first AI network element generates the task offloading policy generation model, the first local model for the first AI network element and/or the second local model for the second AI network element until the joint training is performed on the initial task offloading policy generation model, the first initial local model for the first AI network element and/or the second initial local model for the second AI network element based on input model data for a T^{th} epoch.

In an embodiment of the present disclosure, the first AI network element may determine the iteration epochs T based on an agreement in a protocol, or based on an indication from a network side device, or based on implementation, which will not be particularly defined herein.

Illustratively, the first AI network element determines that the iteration epochs T are 100, 200, 500, etc.

In an embodiment of the present disclosure, the first AI network element determines that the input model data for the first epoch includes the first initial computing frequency, the second initial computing frequency and the initial wireless channel gain.

In a possible embodiment of the present disclosure, the first AI network element determines the second initial computing frequency of the second AI network element in the input model data for the first epoch, and the second initial computing frequency of the second AI network element is reported by the second AI network element to the first AI network element. The first AI network element determines the initial wireless channel gain between the second AI network element and the first AI network element, and the initial wireless channel gain is reported by the second AI network element to the first AI network element.

In an embodiment of the present disclosure, the first AI network element determines that the input model data for the t^{th} epoch includes the updated computing frequency of the first AI network element and/or the updated computing frequency of the second AI network element for the (t−1)^{th} epoch and the initial wireless channel gain which are determined after the first initial local model for the first AI network element and/or the second initial local model for the second AI network element are updated based on the input model data for the (t−1)^{th} epoch.

In an embodiment of the present disclosure, the first AI network element determines that the input model data for the t^{th} epoch includes the updated computing frequencies for the (t−1)^{th} epoch by itself, or based on an agreement in a protocol, or based on an indication from a network side, or based on an indication from a second AI network element, which will not be particularly defined herein.

In a possible embodiment of the present disclosure, the first AI network element determines that the input model data for the t^{th} epoch includes the updated computing frequency of the second AI network element for the (t−1)^{th} epoch, and the updated computing frequency of the second AI network element for the (t−1)^{th} epoch is reported by the second AI network element to the first AI network element.

In an embodiment of the present disclosure, the first AI network element determines that the input model data for the first epoch includes the first initial computing frequency, the second initial computing frequency and the initial wireless channel gain, and performs the joint training on the initial task offloading policy generation model, the first initial local model for the first AI network element and/or the second initial local model for the second AI network element based on the input model data for the first epoch.

Based on the above, the joint training is performed on the initial task offloading policy generation model, the first initial local model for the first AI network element and/or the second initial local model for the second AI network element based on the determined input model data for each epoch, and the task offloading policy generation model, and the first local model for the first AI network element and/or the second local model for the second AI network element are generated until the joint training is performed on the initial task offloading policy generation model, the first initial local model for the first AI network element and/or the second initial local model for the second AI network element based on input model data for the T^{th} epoch.

In some embodiments of the present disclosure, a method for performing, by the first AI network element, the joint training on the initial task offloading policy generation model, and the first initial local model for the first AI network element and/or the second initial local model for the second AI network element based on the input model data for the first epoch includes the following steps.
1. The first initial computing frequency, the second initial computing frequency and the initial wireless channel gain are inputted into the initial task offloading policy generation model to generate an initial task offloading policy, and the initial task offloading policy includes an initial AI task to be executed by the first AI network element and/or an initial AI task to be executed by the second AI network element.
2. A processing result of the initial AI task executed by the first AI network element and/or the initial AI task executed by the second AI network element is determined, and a model updating parameter is generated. The model updating parameter includes an updating parameter of the first AI network element and/or an updating parameter of the second AI network element.
3. In response to the model updating parameter including a first updating parameter of the first AI network element, the initial task offloading policy generation model and/or the first initial local model for the first AI network element are updated based on the first updating parameter.
4. In response to the model updating parameter including a second updating parameter of the second AI network element, the second updating parameter is distributed to the second AI network element.

In an embodiment of the present disclosure, the second AI network element receives the second updating parameter sent by the first AI network element, and updates the second initial local model for the second AI network element based on the second updating parameter.

In an embodiment of the present disclosure, the first AI network element performs the joint training on the initial task offloading policy generation model, and the first initial local model for the first AI network element and/or the second initial local model for the second AI network element based on the first initial computing frequency, the second initial computing frequency and the initial wireless channel gain, so as to generate the task offloading policy generation model, and the first local model for the first AI network element and/or the second local model for the second AI network element.

For the plurality of iterations, the following three steps are mainly taken into consideration: i) the first AI network element performs a task offloading policy; ii) each of the first AI network element and the second AI network element performs local training and computing; iii) the first AI network element collects output results and obtains a weighted average; and iv) the first AI network element issues a model obtained after aggregation (model parameters) to each second AI network element. The iterations are performed on these steps during the entire training. In this process, the following two main objects are to be achieved: i) maximizing a computing rate; and ii) meeting such conditions as executing a delay constraint. The analysis will be given hereinafter.

In the entire AI task processing, no matter whether the AI task is executed by the first AI network element or the second AI network element, an individual task must be completed before a deadline Tmax. x_{i,t}∈{0,1} represents an integral variable, where x_{i,t}=1 represents that an i^{th} task is executed by the first AI network element, and x_{i,t}=0 represents that the i^{th} task is offloaded to the second AI network element.

Step 1: the first AI network element performs local computing.

The first AI network element has stronger computing resources than the second AI network element, so upon the receipt of a task request, the first AI network element at first analyzes which tasks must be computed locally by the first AI network element and which tasks may be issued to the second AI network element for computing. In a case that f0 represents a computing frequency of the first AI network element (cycles/s), t_{k,t} represents a computing time for the k^{th} task for the t^{th} epoch, and 0≤t_{k,t}≤T, a total quantity of bits to be processed by the first AI network element is

$$\frac{{f}_{0} {t}_{k , t}}{M} ,$$

where M represents a CPU cycle number for processing 1-bit task data. Hence, the computing rate of the first AI network element is

$${r}_{i , t}^{L} = \frac{{f}_{0} {t}_{k , t}}{{Mt}_{k , t}} = \frac{{f}_{0}}{M} .$$

Step 2: the AI task is offloaded to the second AI network element for computing.

An uplink communication rate is far less than a downlink communication rate, i.e., an uploading rate is far less than a downloading rate, so a computing rate for an individual task is equal to a sum of the computing rate of the second AI network element and a data uploading rate from the second AI network element to the first AI network element, i.e.,

$${r}_{o , i} = \frac{{f}_{i , t} {t}_{k , t}}{{M}_{i} {t}_{k , t}} + B log ( 1 + \frac{{Ph}_{i , t}^{2}}{{N}_{0}} ) = \frac{{f}_{i , t}}{{M}_{i , t}} + B log ( 1 + \frac{{Ph}_{i , t}^{2}}{{N}_{0}} ) ,$$

where hi represents the wireless channel gain between the first AI network element and the second AI network element, and it is a variable changing dynamically. A weighted overall computing rate of the entire system is

$$Q ( h , f ) \hat{=} {\sum }_{i = 1}^{N} ( ( 1 - {x}_{i , t} ) {r}_{i , t}^{L} + {x}_{i , t} {r}_{i , t}^{o} ) ,$$

where the wireless channel gain h is {hᵢ, h₂, . . . , hᵢ|i∈N}, and the computing frequency f of each second AI network element is {f₁, f₂, . . . , fᵢ|i∈N}. Different tasks k have different computational workloads, and the requirements on the computing resources and the computing frequencies are different too.

Step 3: a time constraint is determined.

In the entire process, the second AI network element performs parallel task processing, so the delay refers to a smaller one of a time for training the local model for the second AI network element and a time for uploading a parameter result. The downlink communication rate is far greater than the uplink communication rate, so a time for issuing, by the first AI network element, an instruction to the second AI network element may be omitted. In addition, the first AI network element has computing resources far stronger than the second AI network element, so the first AI network element may always complete the computing tasks before the second AI network element. In a case that each issued task is split into a plurality of tasks, and

$${t}_{i , t}^{comp} and {t}_{i , t}^{up}$$

represent a time for training the local model for the second AI network element for the task k for the t^{th} epoch and a time for uploading the result respectively,

$${t}_{i , t}^{comp}$$

may depend on: i) a computing time

$${T}_{k , t} = \frac{{D}_{k , t} {M}_{i}}{{f}_{i , t}} ;$$

and ii) a waiting time T_{i,wait} of the task k in a task queue of the second AI network element, where D_{k,t} represents a data volume of the task k for the t^{th} epoch. The waiting time refers to a queueing time of a remaining workload which is currently performed on the second AI network element.

Hence,

$${t}_{k , t}^{comp}$$

may be expressed as

$${t}_{k , t}^{comp} = {T}_{k , t} + {T}_{i , wait} ,$$

and the time for uploading, by the second AI network element, the model parameter is

$${t}_{k , t}^{up} = \frac{{D}_{k , t}}{B log ( 1 + \frac{{Ph}_{i , t}^{2}}{{N}_{0}} )} .$$

At this time, the time for completing, by the second AI network element, the task k needs to meet

$$max \{ {t}_{k , t}^{up} + {t}_{k , t}^{comp} \} \leq {T}_{max} .$$

Step 4: the modeling is optimized.

In a word, a task offloading problem is modeled as follows.

$$P 1 : Q * ( h , f ) = maximize {\sum }_{i = 1}^{N} ( ( 1 - {x}_{i} ) {r}_{L , i} + {x}_{i} {r}_{O , i} )$$

$$subject to : max \{ {t}_{k , t}^{up} + {t}_{k , t}^{comp} \} \leq {T}_{max}$$

$${x}_{i} ∈ \{ 0 , 1 \}$$

A problem P1 is a mixed-integer non-convex optimization problem with a complexity at an exponential level, so it is very difficult to resolve this problem within a limited time period. Here, DRL is used for the offload policy and allocation, so as to dynamically update the offloading policy based on a task type and a channel state.

Before issuing the task, the first AI network element sinks the DNN model to the second AI network element for training. Within a time constraint range, the first AI network element obtains the offloading policy via the DRL model, and sends it to each second AI network element. Each second AI network element inputs a channel gain h_{i,t} and a computing frequency f_{i,t} into the DNN model. In the t^{th} epoch, the DNN model obtains the offloading policy

$${x}_{i , t}^{*} = {f}_{{θ}_{i , t}} ( {h}_{i , t} , {f}_{i , t} )$$

based on h_{i,t} and f_{i,t}, where θ_{i,t} represents a quantity of neurons and a quantity of layers of a neural network. Then, the DNN model uploads the offloading policy to the first AI network element. After all the subtask offloading policies have been determined, an offloading action of the first AI network element is expressed as

$${x}_{t}^{*} = \{ {x}_{i , t}^{*} \vert {x}_{i , t}^{*} ∈ [ 0 , 1 ] , i = 1 , … , N \} .$$

Then, a slack offloading action x*ₜ is quantized into m binary offloading action combinations using a threshold quantization method. An order-preserving quantization method follows the following rule:

$${x}_{i ,}^{k} =$$

After the first AI network element has obtained all the m offloading action combinations, a problem P2 is resolved individually for each offloading policy to obtain a weighted overall computing rate Q(h, f).

$$P 2 : Q * ( h , f ) = maximize {\sum }_{i = 1}^{N} ( ( 1 - {x}_{i} ) {r}_{L , i} + {x}_{i} {r}_{O , i} )$$

$$subject to : max \{ {t}_{k , t}^{up} + {t}_{k , t}^{comp} \} \leq {T}_{max}$$

Finally, x̅ₜ corresponding to an optimum Q*(h, f) is selected as a final offloading result, After the first AI network element has obtained the offloading action, a newly-obtained state-action pair ((h_{i,t}, f_{i,t}, x̅_{i,t}) is added into a memory.

The DRL offloading policy is updated for each epoch. At a policy updating stage for the t^{th} epoch, each second AI network element selects an up-to-date state-action pair (h_{i,t}, f_{i,t}, x̅_{i,t}) in the memory to train the DNN model. After the training, the DNN model updates the parameter θₜ into θₜ₊₁ using a SGD algorithm. A newly-generated offloading policy πθₜ₊₁ is used in a next epoch to generate the offloading policy

$${x}_{t + 1}^{*}$$

based on a newly-observed channel state h_{i,t+1} and a new computing frequency f_{i,t+1}. Once the channel state and the task information change, the DRL method may be iterated continuously, and the DNN model may improve the offloading policy π_{θ}_{ₜ} continuously, so as to improve a final training result.

Algorithm 1: DRL-based dynamic offloading policy solution algorithm
Input: the task type, the wireless channel gain ht for each epoch, and the computing

frequency fₜ.

```
Output: an optimum offloading policy x̅ₜ for all the second AI network elements.
  1. A DNN model parameter θ is initialized, and the memory R is emptied.
  2. The iteration epochs T are set.
  3. For the iteration epoch t = 1, 2, . . . , T:
  $4. A slack offloading action {x}_{i , t}^{*} = {f}_{{θ}_{i , t}} ( {h}_{i , t} , {f}_{i , t} ) is generated for each second AI$
```

network element, and uploaded to the first AI network element for decision.

```
  ${\tilde{x}}_{t} is quantized into m binomial action combination {x}_{k} = {g}_{m} ( {x}_{t}^{*} ) .$
  6. Q*(h,f) is calculated for all {xₖ}.
  $An optimum action {\overline{x}}_{t} = {arg max}_{{x}_{k}} {Q}^{*} ( h , f ) is selected$
  8. For each second AI element:
  9. The memory is updated, and (h_{i,t}, f_{i,t}, x_{i,t}) is added into the memory R.
10. An up-to-date state-action pair is selected in the memory to train the DNN model,
```

and θ_{i,t} is updated to θ_{i,t+1} using SGD.

11. End.
12. The parameters θ_{i,t} of all AIi are sent to the first AI network element.
13. A weighted average of the parameters is obtained as a global model parameter

θ_{g,t}.

14. The global model parameter is issued to each second AI network element.
15. End.

Referring to FIG. 8 which is a flow chart of an AI task processing method according to an embodiment of the present disclosure, the method includes, but not limited to, the following steps.

S81: an AMF network element sends an AI service request message to a first AI network element. The AI service request message is used to indicate an AI service to be provided.

S82: the first AI network element determines at least one AI task based on the AI service request message.

S83: the first AI network element determines a first processing parameter of the first AI network element and a second processing parameter of a second AI network element.

S84: the first AI network element determines a first task to be executed by the first AI network element in the at least one AI task based on the at least one AI task, the first processing parameter and the second processing parameter.

Relevant description about S81 to S84 may refer to that mentioned in the above embodiments, and thus will not be particularly defined herein.

S85: the first AI network element executes the first task to generate a first processing result.

S86: the first AI network element sends the first processing result to the AMF network element.

In an embodiment of the present disclosure, the first AI network element determines the first task to be executed by the first AI network element in the at least one AI task based on the at least one AI task, the first processing parameter and the second processing parameter. In this case, the first AI network element performs the first task to generate the first processing result, and sends the first processing result to the AMF network element.

It should be appreciated that, the first processing result received by the AMF network element from the first AI network element is sent to a terminal device via a RAN (e.g., transparent transmission), so as to feed the processing result of the AI service requested by the terminal device back to the terminal device, thereby to provide the AI service for the terminal device.

Upon the receipt of the first processing result sent by the AMF network element, the terminal device may send indication information to the AMF network device to indicate that it has received the first processing result. In addition, the indication information is further used to indicate whether or not the terminal device is satisfied with the first processing result, e.g., indicate that the first processing result is accurate or inaccurate.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, and determines the first task to be executed by the first AI network element in the at least one AI task based on the at least one AI task, the first processing parameter and the second processing parameter. Then, the first AI network element executes the first task to generate the first processing result, and sends the first processing result to the AMF network element. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for a user.

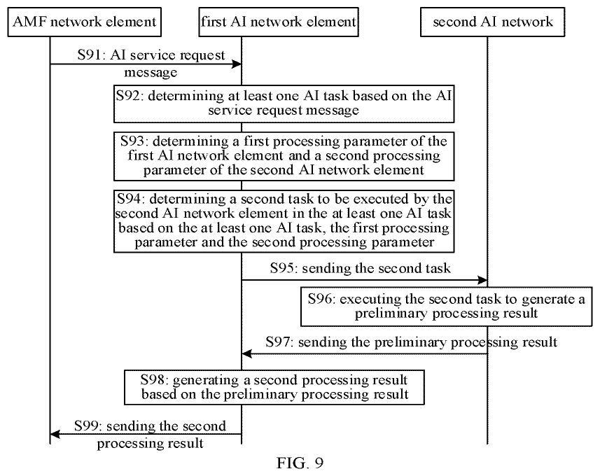

Referring to FIG. 9 which is a flow chart of an AI task processing method according to an embodiment of the present disclosure, the method includes, but not limited to, the following steps.

S91: an AMF network element sends an AI service request message to a first AI network element. The AI service request message is used to indicate an AI service to be provided.

S92: the first AI network element determines at least one AI task based on the AI service request message.

S93: the first AI network element determines a first processing parameter of the first AI network element and a second processing parameter of a second AI network element.

S94: the first AI network element determines a second task to be executed by the second AI network element in the at least one AI task based on the at least one AI task, the first processing parameter and the second processing parameter.

Relevant description about S91 to S94 may refer to that mentioned in the above embodiments, and thus will not be particularly defined herein.

S95: the first AI network element sends the second task to the second AI network element.

S96: the second AI network element executes the second service to generate a preliminary processing result.

S97: the second AI network element sends the preliminary processing result to the first AI network element.

S98: the first AI network element generates a second processing result based on the preliminary processing result.

S99: the first AI network element sends the second processing result to the AMF network element, and the second processing result is determined by the first AI network element based on the preliminary processing result.

In an embodiment of the present disclosure, the first AI network element determines the second task to be executed by the second AI network element in the at least one AI task based on the at least one AI task, the first processing parameter and the second processing parameter. In this case, the first AI network element sends the second task to the second AI network element, and the second AI network element executes the second task to generate the preliminary processing result. Further, the second AI network element sends the preliminary processing result to the first AI network element.

The first AI network element receives the preliminary processing result sent by the second AI network element, processes the preliminary processing result to generate the second processing result, and sends the second processing result to the AMF network element.

It should be appreciated that, the second processing result received by the AMF network element from the first AI network element is sent to a terminal device via a RAN (e.g., transparent transmission), so as to feed the processing result of the AI service requested by the terminal device back to the terminal device, thereby to provide the AI service for the terminal device.

Upon the receipt of the second processing result sent by the AMF network element, the terminal device may send indication information to the AMF network device to indicate that it has received the second processing result. In addition, the indication information is further used to indicate whether or not the terminal device is satisfied with the second processing result, e.g., indicate that the second processing result is accurate or inaccurate.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, determines the second task to be executed by the second AI network element in the at least one AI task based on the at least one AI task, the first processing parameter and the second processing parameter, and sends the second task to the second AI network element. Then, the second AI network element executes the second task to generate the preliminary processing result, and sends the preliminary processing result to the first AI network element. The first AI network element generates the second processing result based on the preliminary processing result, and sends the second processing result to the AMF network element, and the second processing result is determined by the first AI network element based on the preliminary processing result. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for the user.

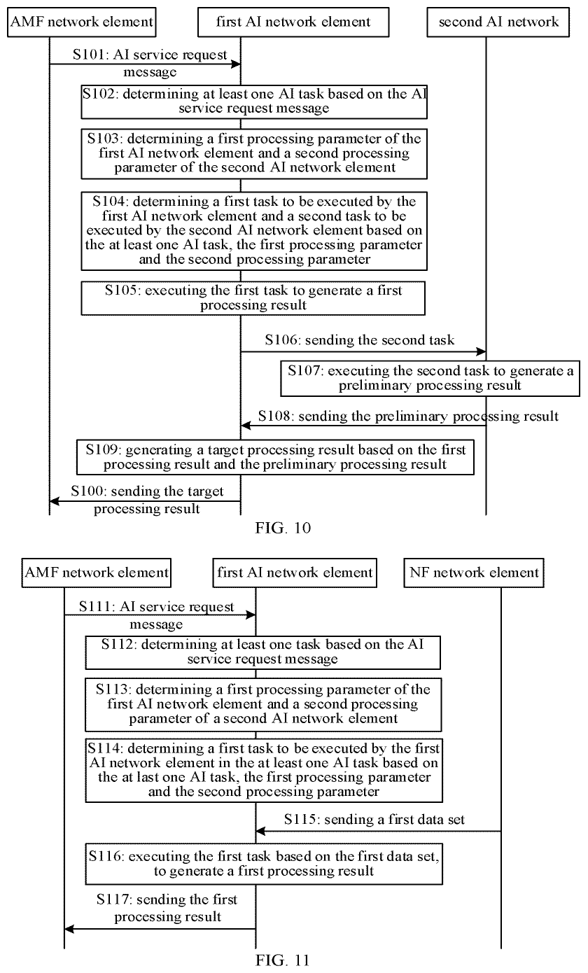

Referring to FIG. 10 which is a flow chart of an AI task processing method according to an embodiment of the present disclosure, the method includes, but not limited to, the following steps.

S101: an AMF network element sends an AI service request message to a first AI network element. The AI service request message is used to indicate an AI service to be provided.

S102: the first AI network element determines at least one AI task based on the AI service request message.

S103: the first AI network element determines a first processing parameter of the first AI network element and a second processing parameter of a second AI network element.

S104: the first AI network element determines a first task to be executed by the first AI network element and a second task to be executed by the second AI network element in the at least one AI task based on the at least one AI task, the first processing parameter and the second processing parameter.

Relevant description about S101 to S104 may refer to that mentioned in the above embodiments, and thus will not be particularly defined herein.

S105: the first AI network element executes the first task to generate a first processing result.

S106: the first AI network element sends the second task to the second AI network element.

S107: the second AI network element executes the second task to generate a preliminary processing result.

S108: the second AI network element sends the preliminary processing result to the first AI network element.

S109: the first AI network element generates a target processing result based on the first processing result and the preliminary processing result.

S100: the first AI network element sends the target processing result to the AMF network element.

In an embodiment of the present disclosure, the first AI network element determines the first task to be executed by the first AI network element in the at least one AI task based on the at least one AI task, the first processing parameter and the second processing parameter. In this case, the first AI network element executes the first task to generate the first processing result.

In an embodiment of the present disclosure, the first AI network element determines the second task to be executed by the second AI network element in the at least one AI task based on the at least one AI task, the first processing parameter and the second processing parameter. In this case, the first AI network element sends the second task to the second AI network element, and the second AI network element executes the second task to generate the preliminary processing result. Further, the second AI network element sends the preliminary processing result to the first AI network element.

The first AI network element receives the preliminary processing result sent by the second AI network element, generates the target processing result based on the first processing result and the preliminary processing result, and sends the target processing result to the AMF network element.

It should be appreciated that, the target processing result received by the AMF network element from the first AI network element is sent to a terminal device via a RAN (e.g., transparent transmission), so as to feed the processing result of the AI service requested by the terminal device back to the terminal device, thereby to provide the AI service for the terminal device.

Upon the receipt of the target processing result sent by the AMF network element, the terminal device may send indication information to the AMF network device to indicate that it has received the target processing result. In addition, the indication information is further used to indicate whether or not the terminal device is satisfied with the target processing result, e.g., indicate that the target processing result is accurate or inaccurate.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, determines the first task to be executed by the first AI network element and the second task to be executed by the second AI network element in the at least one AI task based on the at least one AI task, the first processing parameter and the second processing parameter, and sends the second task to the second AI network element. Then, the second AI network element executes the second task to generate the preliminary processing result, and sends the preliminary processing result to the first AI network element. The first AI network element generates the target processing result based on the preliminary processing result and the first processing result, and sends the target processing result to the AMF network element. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for the user.

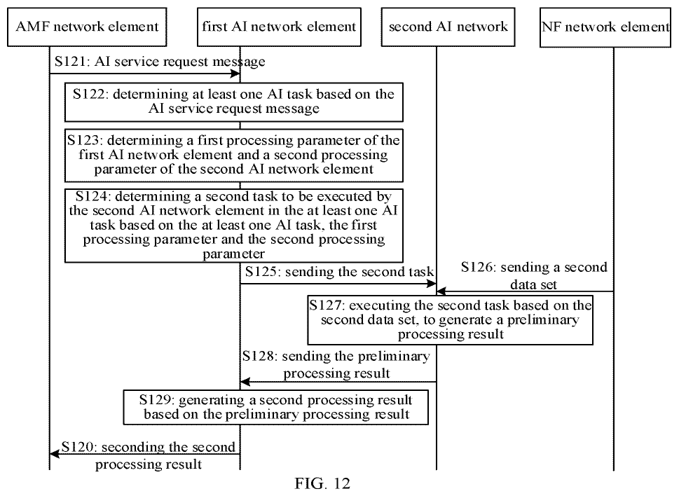

Referring to FIG. 11 which is a flow chart of an AI task processing method according to an embodiment of the present disclosure, the method includes, but not limited to, the following steps.

S111: an AMF network element sends an AI service request message to a first AI network element. The AI service request message is used to indicate an AI service to be provided.

S112: the first AI network element determines at least one AI task based on the AI service request message.

S113: the first AI network element determines a first processing parameter of the first AI network element and a second processing parameter of a second AI network element.

S114: the first AI network element determines a first task to be executed by the first AI network element in the at least one AI task based on the at least one AI task, the first processing parameter and the second processing parameter.

Relevant description about S111 to S114 may refer to that mentioned in the above embodiments, and thus will not be particularly defined herein.

S115: the first AI network element receives a first data set sent by a NF network element.

S116: the first AI network elements executes the first task based on the first data set to generate a first processing result.

S117: the first AI network element sends the first processing result to the AMF network element.

In an embodiment of the present disclosure, the first AI network element determines the first task to be executed by the first AI network element in the at least one AI task based on the at least one AI task, the first processing parameter and the second processing parameter. In this case, the first AI network element receives the first data set sent by the NF network element, executes the first task based on the first data set to generate the first processing result, and sends the first processing result to the AMF network element.

The NF network element may be a unified data repository (UDR) network element and/or an unstructured data storage function (UDSF) network element. The first data set may include structured data or unstructured data, and the data in the first data set is stored in the UDR network element and/or the UDSF network element in a case that a terminal device is registered and initiates a service request.

It should be appreciated that, the first processing result received by the AMF network element from the first AI network element is sent to the terminal device via a RAN (e.g., transparent transmission), so as to feed the processing result of the AI service requested by the terminal device back to the terminal device, thereby to provide the AI service for the terminal device.

Upon the receipt of the first processing result sent by the AMF network element, the terminal device may send indication information to the AMF network device to indicate that it has received the first processing result. In addition, the indication information is further used to indicate whether or not the terminal device is satisfied with the first processing result, e.g., indicate that the first processing result is accurate or inaccurate.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, determines the first task to be executed by the first AI network element in the at least one AI task based on the at least one AI task, the first processing parameter and the second processing parameter, receives the first data set sent by the NF network element, executes the first task based on the first data set to generate the first processing result, and sends the first processing result to the AMF network element. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for the user.

Referring to FIG. 12 which is a flow chart of an AI task processing method according to an embodiment of the present disclosure, the method includes, but not limited to, the following steps.

S121: an AMF network element sends an AI service request message to a first AI network element. The AI service request message is used to indicate an AI service to be provided.

S122: the first AI network element determines at least one AI task based on the AI service request message.

S123: the first AI network element determines a first processing parameter of the first AI network element and a second processing parameter of a second AI network element.

S124: the first AI network element determines a second task to be executed by the second AI network element in the at least one AI task based on the at least one AI task, the first processing parameter and the second processing parameter.

Relevant description about S121 to S124 may refer to that mentioned in the above embodiments, and thus will not be particularly defined herein.

S125: the first AI network element seconds the second task to the second AI network element.

S126: the second AI network element receives a second data set sent by a NF network element.

S127: the second AI network element executes the second task based on the second data set to generate a preliminary processing result.

S128: the second AI network element sends the preliminary processing result to the first AI network element.

S129: the first AI network element generates a second processing result based on the preliminary processing result.

S120: the first AI network element sends the second processing result to the AMF network element, and the second processing result is determined by the first network element based on the preliminary processing result.

In an embodiment of the present disclosure, the first AI network element determines the second task to be executed by the second AI network element in the at least one AI task based on the at least one AI task, the first processing parameter and the second processing parameter. In this case, the first AI network element sends the second task to the second network element, and the second AI network element receives the second data set sent by the NF network element and executes the second task based on the second data set to generate the preliminary processing result. Further, the second AI network element sends the preliminary processing result to the first AI network element.

The NF network element may be a UDR network element and/or an UDSF network element. The second data set may include structured data or unstructured data, and the data in the second data set is stored in the UDR network element and/or the UDSF network element in a case that a terminal device is registered and initiates a service request.

The first AI network element receives the preliminary processing result sent by the second AI network element, processes the preliminary processing result to generate the second processing result, and sends the second processing result to the AMF network element.

It should be appreciated that, the second processing result received by the AMF network element from the first AI network element is sent to the terminal device via a RAN (e.g., transparent transmission), so as to feed the processing result of the AI service requested by the terminal device back to the terminal device, thereby to provide the AI service for the terminal device.

Upon the receipt of the second processing result sent by the AMF network element, the terminal device may send indication information to the AMF network device to indicate that it has received the second processing result. In addition, the indication information is further used to indicate whether or not the terminal device is satisfied with the second processing result, e.g., indicate that the second processing result is accurate or inaccurate.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, determines the second task to be executed by the second AI network element in the at least one AI task based on the at least one AI task, the first processing parameter and the second processing parameter, and sends the second task to the second AI network element. The second AI network element receives the second data set sent by the NF network element, executes the second task based on the second data set to generate the preliminary processing result, and sends the preliminary processing result to the first AI network element. The first AI network element generates the second processing result based on the preliminary processing result, and sends the second processing result to the AMF network element, and the second processing result is determined by the first AI network element based on the preliminary processing result. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for the user.

Referring to FIG. 13 which is a flow chart of an AI task processing method according to an embodiment of the present disclosure, the method includes, but not limited to, the following steps.

S131: an AMF network element sends an AI service request message to a first AI network element. The AI service request message is used to indicate an AI service to be provided.

S132: the first AI network element determines at least one AI task based on the AI service request message.

S133: the first AI network element determines a first processing parameter of the first AI network element and a second processing parameter of a second AI network element.

S134: the first AI network element determines a second task to be executed by the first AI network element in the at least one AI task based on the at least one AI task, the first processing parameter and the second processing parameter.

S135: the first AI network element sends the second task to the second AI network element.

S136: the second AI network element executes the second task to generate a preliminary processing result.

S137: the second AI network element sends the preliminary processing result to the first AI network element.

Relevant description about S131 to S137 may refer to that mentioned in the above embodiments, and thus will not be particularly defined herein.

S138: the first AI network element sends a response message to the second AI network element, and the response message is used to indicate that the first AI network element has received the preliminary processing result.

In an embodiment of the present disclosure, in a case that the first AI network element has received the preliminary processing result sent by the second AI network element, the first AI network element sends the response message to the second AI network element, so as to notify the second AI network element that the preliminary processing result has been received by the first AI network element.

S139: the first AI network element generates a second processing result based on the preliminary processing result.

S130: the first AI network element sends the second processing result to the AMF network element, and the second processing result is determined by the first AI network element based on the preliminary processing result.

Relevant description about S139 to S130 may refer to that mentioned in the above embodiments, and thus will not be particularly defined herein.

According to the embodiments of the present disclosure, the AMF network element sends the AI service request message to the first AI network element, and the AI service request message is used to indicate the AI service to be provided. The first AI network element determines the at least one AI task based on the AI service request message, determines the first processing parameter of the first AI network element and the second processing parameter of the second AI network element, determines the second task to be executed by the second AI network element in the at least one AI task based on the at least one AI task, the first processing parameter and the second processing parameter, and sends the second task to the second AI network element. The second AI network element executes the second task to generate the preliminary processing result, and sends the preliminary processing result to the first AI network element. The first AI network element sends the response message to the second AI network element, and the response message is used to indicate that the first AI network element has received the preliminary processing result. Then, the first AI network element generates the second processing result based on the preliminary processing result, and sends the second processing result to the AMF network element, and the second processing result is determined by the first AI network element based on the preliminary processing result. In this way, the first AI network element can schedule the AI tasks in a classified manner and allocate resources based on the scheduling, so as to reduce the overheard, allocate the resources appropriately, and perform the AI service more efficiently and flexibly. In addition, it is able to rapidly and efficiently perform the AI task, and provide the satisfactory AI service for the user.

In the above embodiments of the present disclosure, the technical solutions have been described mainly in terms of the interaction between the devices. It should be appreciated that, in order to achieve the above-mentioned functions, each device includes a hardware structure and/or software modules for achieving the functions. It is obvious for a person skilled in the art that, the present disclosure may be implemented in the form of hardware or a combination of hardware and computer software in conjunction with algorithm steps in each instance described in the embodiments of the present disclosure. Whether or not the function is executed by hardware or by driving hardware using computer software depends on specific applications or design constraints of the technical solution. Different methods may be adopted with respect to the specific applications so as to achieve the described functions, without departing from the scope of the present disclosure.

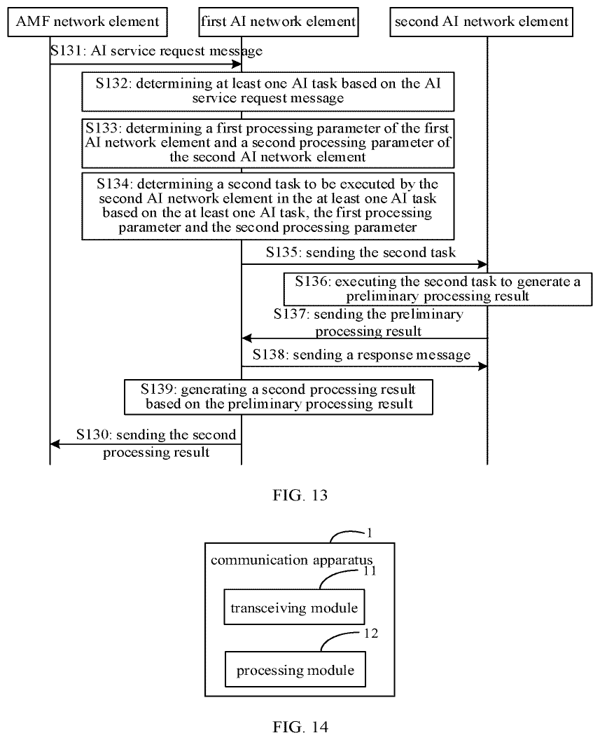

Referring to FIG. 14 which is a block diagram of a communication apparatus 1 according to an embodiment of the present disclosure, the communication apparatus 1 includes a transceiving module 11 and a processing module 12. The transceiving module 11 includes a transmission module and/or a reception module, the transmission module is configured to achieve a transmission function, the reception module is configured to achieve a reception function, and the transceiving module 11 is configured to achieve the transmission function and/or the reception function.

In a case of being applied to a first AI network element, the communication apparatus 1 includes a transceiving module 11 and a processing module 12.

The transceiving module 11 is configured to receive an AI service request message sent by an AMF network element, wherein the AI service request message is used to indicate an AI service to be provided.

The processing module 12 is configured to determine at least one AI task based on the AI service request message.

The processing module 12 is further configured to determine a first processing parameter of the first AI network element and a second processing parameter of a second AI network element.

The processing module 12 is further configured to determine a first task to be executed by the first AI network element and/or a second task to be executed by the second AI network element based on the at least one AI task, the first processing parameter and the second processing parameter.

In some embodiments of the present disclosure, the processing module 12 is further configured to: determine a target task type of the at least one AI task; and determine the first task to be executed by the first AI network element and/or the second task to be executed by the second AI network element in the at least one AI task based on the target task type, the first processing parameter and the second processing parameter. The first processing parameter includes a first task type supported to be processed by the first AI network element, and the second processing parameter includes a second task type supported to be processed by the second AI network element.

In some embodiments of the present disclosure, the AI service request message is further used to indicate a time threshold for obtaining a processing result, the processing module 12 is further configured to determine a first duration for obtaining a first processing result based on the at least one AI task and the first processing parameter, and the first processing result is obtained via processing, by the first AI network element, the first task.

The processing module 12 is further configured to determine a second duration for obtaining a second processing result based on the at least one AI task and the second processing parameter, and the second processing result is obtained via processing, by the second AI network element, the second task.

The processing module 12 is further configured to determine the first task to be executed by the first AI network element and/or the second task to be executed by the second AI network element in the at least one AI task based on the time threshold, the first duration and the second duration.

In some embodiments of the present disclosure, the processing module 12 is further configured to: in response to meeting t_{0,k}≤Tₘₐₓ, determine that a k^{th} AI task is to be executed by the first AI network element; and/or in response to meeting

$${t}_{i , k}^{comp} + {t}_{i , k}^{up} \leq {T}_{max} ,$$

determine that the k^{th} AI task is to be executed by an i^{th} second AI network element,
where Tₘₐₓ represents the time threshold;
t_{0,k} represents the first duration for processing, by the first AI network element, the k^{th} AI task,

$${t}_{0 , k} = \frac{{D}_{k}}{{r}_{0 , k}} ,$$

Dₖ represents a data volume of the k^{th} AI task, and r_{0,k} represents a computing rate at which the k^{th} AI task is processed by the first AI network element;

$${t}_{i , k}^{comp} + {t}_{i , k}^{up}$$

represents the second duration for processing, by the i^{th} second AI network element, the k^{th} AI task;

$${t}_{i , k}^{comp}$$

represents a computing time for processing, by the i^{th} second AI network element, the k^{th} AI task;

$${t}_{i , k}^{comp} = {t}_{i , k} + {T}_{i , k} , {t}_{i , k} = \frac{{D}_{k}}{{r}_{i , k}^{comp}} , {r}_{i , k}^{comp}$$

represents a computing rate at which the k^{th} AI task is processed by the i^{th} second AI network element, and T_{i,k} represents a waiting delay;

$${t}_{i , k}^{up}$$

represents an uploading time for uploading, by the i^{th} second AI network element, a processing result of the k^{th} AI task; and

$${t}_{i , k}^{up} = \frac{{D}_{k}}{{r}_{i , k}^{up}} , and {r}_{i , k}^{up}$$

represents an uploading rate at which the processing result of the k^{th} AI task is uploaded by the i^{th} second AI network element,
where i and k are both integers.

In some embodiments of the present disclosure, the processing module 12 is further configured to determine the computing rate r_{0,k} at which the k^{th} AI task is processed by the first AI network element,
where

$${r}_{0 , k} = \frac{{f}_{0} {t}_{0 , k}}{M {t}_{0 , k}} = \frac{{f}_{0}}{M} ,$$

f₀ represents a computing frequency of the first AI network element, and M represents a CPU cycle number for processing, by the first AI network element, 1-bit task data.

In some embodiments of the present disclosure, the processing module 12 is further configured to determine the computing rate

$${r}_{i , k}^{comp}$$

at which the k^{th} AI task is processed by the i^{th} second AI network element, the uploading rate

$${r}_{i , k}^{up}$$

at which the processing result of the k^{th} AI task is uploaded, and the waiting relay T_{i,k},
where

$${r}_{i , k}^{comp} = \frac{{f}_{i} {t}_{i , k}}{{M}_{i} {t}_{i , k}} = \frac{{f}_{i}}{{M}_{i}} , {r}_{i , k}^{up} = B log ( 1 + \frac{{Ph}_{i}^{2}}{{N}_{0}} ) ,$$

B represents a bandwidth, P represents power, N₀ represents a gaussian white noise, hᵢ represents a wireless channel gain between the i^{th} second AI network element and the first AI network element, fᵢ represents a computing frequency of the i^{th} second AI network element, and Mᵢ represents a CPU cycle number for processing, by the i^{th} second AI network element, 1-bit task data.

In some embodiments of the present disclosure, the processing module 12 is further configured to: determine a task offloading policy generation model; and input the computing frequency of the first AI network element, the computing frequency of the second AI network element and the wireless channel gain between the second AI network element and the first AI network into the task offloading policy generation model to generate a target task offloading policy. The target task offloading policy includes the first task to be executed by the first AI network element and/or the second task to be executed by the second AI network element in the at least one AI task, the first processing parameter includes the computing frequency of the first AI network element, and the second processing parameter includes the computing frequency of the second AI network element and the wireless channel gain between the second AI network element and the first AI network element.

In some embodiments of the present disclosure, the processing module 12 is further configured to initialize a model parameter, and determine an initial task offloading policy generation model.

The processing module 12 is further configured to determine a first initial computing frequency of the first AI network element, a second initial computing frequency of the second AI network element, and an initial wireless channel gain between the second AI network element and the first AI network element.

The processing module 12 is further configured to perform joint training on the initial task offloading policy generation model, a first initial local model for the first AI network element and/or a second initial local model for the second AI network element based on the first initial computing frequency, the second initial computing frequency and the initial wireless channel gain, to generate the task offloading policy generation model and a first local model for the first AI network element and/or a second local model for the second AI network element.

In some embodiments of the present disclosure, the processing module 12 is further configured to determine iteration epochs T, where T is a positive integer.

The processing module 12 is further configured to determine that input model data for a first epoch includes the first initial computing frequency, the second initial computing frequency and the initial wireless channel gain.

The processing module 12 is further configured to determine that input model data for a t^{th} epoch includes an updated computing frequency of the first AI network element and/or an updated computing frequency of the second AI network element for a (t−1)^{th} epoch and the initial wireless channel gain which are determined after the first initial local model for the first AI network element and/or the second initial local model for the second AI network element are updated based on input model data for the (t−1)^{th} epoch, where 2≤t≤T.

The processing module 12 is further configured to sequentially perform joint training on the initial task offloading policy generation model, the first initial local model for the first AI network element and/or the second initial local model for the second AI network element based on input model data for each epoch.

The processing module 12 is further configured to generate the task offloading policy generation model, the first local model for the first AI network element and/or the second local model for the second AI network element until the joint training is performed on the initial task offloading policy generation model, the first initial local model for the first AI network element and/or the second initial local model for the second AI network element based on input model data for a T^{th} epoch.

In some embodiments of the present disclosure, the processing module 12 is further configured to input the first initial computing frequency, the second initial computing frequency and the initial wireless channel gain into the initial task offloading policy generation model to generate an initial task offloading policy, and the initial task offloading policy includes an initial AI task to be executed by the first AI network element and/or an initial AI task to be executed by the second AI network element.

The processing module 12 is further configured to determine a processing result of the initial AI task executed by the first AI network element and/or the initial AI task executed by the second AI network element, and generating a model updating parameter, and the model updating parameter includes an updating parameter of the first AI network element and/or an updating parameter of the second AI network element.

The processing module 12 is further configured to, in response to the model updating parameter including a first updating parameter of the first AI network element, update the initial task offloading policy generation model and/or the first initial local model for the first AI network element based on the first updating parameter.

The processing module 12 is further configured to, in response to the model updating parameter including a second updating parameter of the second AI network element, distribute the second updating parameter to the second AI network element.

In some embodiments of the present disclosure, the processing module 12 is further configured to execute the first task in response to determining the first task to be executed by the first AI network element to generate a first processing result.

In some embodiments of the present disclosure, the transceiving module 11 is further configured to, in response to determining the first task to be executed by the first AI network element, receive a first data set sent by a NF network element.

The processing module 12 is further configured to execute the first task based on the first data set to generate the first processing result.

In some embodiments of the present disclosure, the transceiving module 11 is further configured to send the first processing result to the AMF network element.

In some embodiments of the present disclosure, the transceiving module 11 is further configured to, in response to determining the second task to be executed by the second AI network element, send the second task to the second AI network element.

The transceiving module 11 is further configured to receive a preliminary processing result sent by the second AI network element, and the preliminary processing result is generated via executing, by the second AI network element, the second task.

In some embodiments of the present disclosure, the transceiving module 11 is further configured to send a response message to the second AI network element, and the response message is used to indicate that the first AI network element has received the preliminary processing result.

In some embodiments of the present disclosure, the transceiving module 11 is further configured to send the second processing result to the AMF network element, and the second processing result is determined by the first AI network element based on the preliminary processing result.

In some embodiments of the present disclosure, the processing module 12 is further configured to, in response to determining the first processing result and the preliminary processing result, process the first processing result and the preliminary processing result to generate a target processing result.

In some embodiments of the present disclosure, the transceiving module 11 is further configured to send the target processing result to the AMF network element.

In a case of being applied to an AMF network element, the communication apparatus 1 includes a transceiving module 11.

The transceiving module 11 is configured to receive an AI service establishment request message sent by a terminal device, and the AI service establishment request message is used to indicate an AI service required by the terminal device.

The transceiving module 11 is further configured to send an AI service request message to a first AI network element, the AI service request message is used to indicate the AI service to be provided, and the first AI network element determines at least one AI task, a first processing parameter of the first AI network element and a second processing parameter of a second AI network element based on the AI service request message, and determines a first task to be executed by the first AI network element and/or a second task to be executed by the second AI network element in the at least one AI task based on the at least one AI task, the first processing parameter and the second processing parameter.

In some embodiments of the present disclosure, the transceiving module 11 is further configured to receive a first processing result sent by the first AI network element, and the first processing result is generated via executing, by the first AI network element, the first task.

In some embodiments of the present disclosure, the transceiving module 11 is further configured to receive a second processing result sent by the first AI network element, the second processing result is determined by the first AI network element based on a preliminary processing result, and the preliminary processing result is generated via executing, by the second AI network element, the second task.

In some embodiments of the present disclosure, the transceiving module 11 is further configured to receive a target processing result sent by the first AI network element, the target processing result is generated via processing, by the first AI network element, a first processing result and a preliminary processing result in a case of determining the first processing result and the preliminary processing result, the first processing result is generated via executing, by the first AI network element, the AI task, and the preliminary processing result is generated via executing, by the second AI network element, the AI task.

In a case of being applied to a second AI network element, the communication apparatus 1 includes a transceiving module 11 and a processing module 12.

The transceiving module 11 is configured to receive a second task sent by a first AI network element, the second task is determined by the first AI network element to be executed by the second AI network element based on at least one AI task, a determined first processing parameter of the first AI network element and a determined second processing parameter of the second AI network element, and sent by the first AI network element to the second AI network element, the at least one AI task is determined by the first AI network element based on an AI service request message sent by an AMF network element, and the AI service request message is used to indicate an AI service to be provided.

In some embodiments of the present disclosure, the processing module 12 is configured to execute the second task to generate a preliminary processing result.

In some embodiments of the present disclosure, the transceiving module 11 is further configured to receive a second data set sent by a NF network element.

The processing module 12 is further configured to execute the second task based on the second data set to generate the preliminary processing result.

In some embodiments of the present disclosure, the transceiving module 11 is further configured to receive a second updating parameter sent by the first AI network element.

The processing module 12 is further configured to update an initial local model for the second AI network element based on the second updating parameter.

In some embodiments of the present disclosure, the transceiving module 11 is further configured to send the preliminary processing result to the first AI network element.

In some embodiments of the present disclosure, the transceiving module 11 is further configured to receive a response message sent by the first AI network element, and the response message is used to indicate that the first AI network element has received the preliminary processing result.

For the communication apparatus 1 in the above embodiments of the present disclosure, a specific mode for executing, by each module, the operation has already been described in details in the above method embodiments, and thus will not be particularly defined herein.

The communication apparatus 1 in the above embodiments of the present disclosure has a same or similar beneficial effect as the AI task processing method in the above embodiments of the present disclosure, which will not be particularly defined herein.

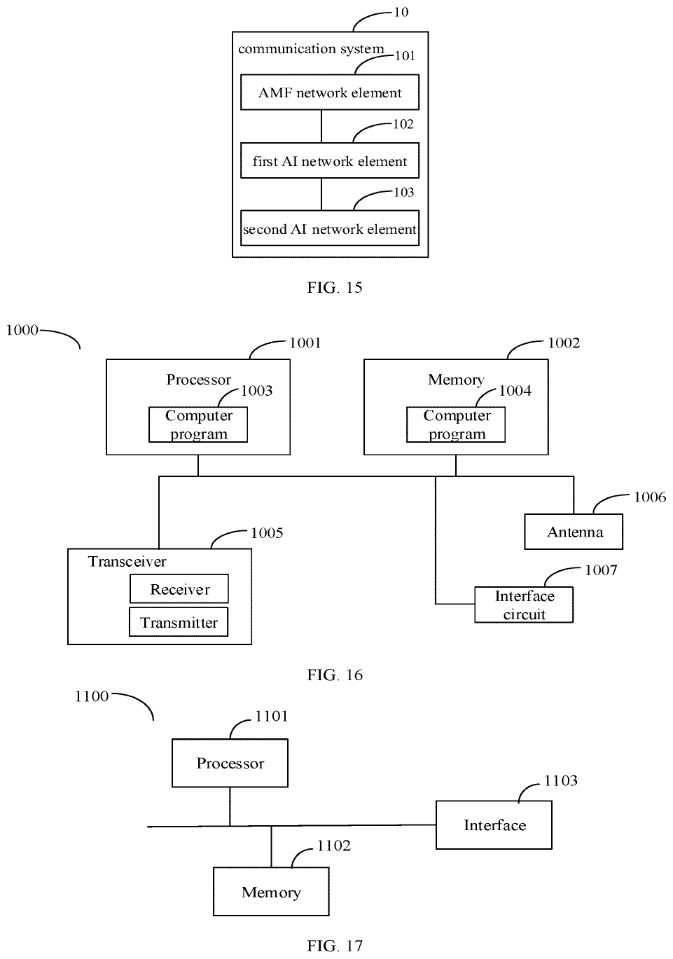

Referring to FIG. 15 which is a block diagram of a communication system according to one embodiment of the present disclosure, the communication system 10 includes an AMF network element 101, a first AI network element 102 and a second AI network element 103.

The AMF network element 101 is configured to receive an AI service establishment request message sent by a terminal device, and send an AI service request message to the first AI network element. The AI service establishment request message is used to indicate an AI service required by the terminal device, and the AI service request message is used to indicate the AI to be provided.

The first AI network element 102 is configured to: receive the AI service request message sent by the AMF network element, wherein the AI service request message is used to indicate the AI service to be provided; determine at least one AI task based on the AI service request message; determine a first processing parameter of the first AI network element and a second processing parameter of the second AI network element; and determine a first task to be executed by the first AI network element and/or a second task to be executed by the second AI network element in the at least one task based on the at least one AI task, the first processing parameter and the second processing parameter.

The first AI network element 102 is further configured to, in response to determining the second task to be executed by the second AI network element, send the second task to the second AI network element.

The second AI network element 103 is configured to receive the second task sent by the first AI network element.

In an embodiment of the present disclosure, the AMF network element 101, the first AI network element 102 and the second AI network element 103 are used to implement the AI task processing method provided in the above-mentioned embodiments of the present disclosure. A specific mode of executing the operation by each of the AMF network element 101, the first AI network element 102 and the second AI network element 103 has already been described in details in the above method embodiments, and thus will not be particularly defined herein.

The communication system 10 provided in the embodiments of the present disclosure has a same or similar beneficial effect as the AI task processing method in the above-mentioned embodiments of the present disclosure, which will thus not be particularly defined herein.

Referring to FIG. 16 which is a block diagram of a communication apparatus 1000 according to an embodiment of the present disclosure, the communication apparatus 1000 maybe an AMF network element, a first AI network element or a second AI network element. The communication apparatus is used to implement the method in the above-mentioned method embodiments, which will not be particularly defined herein.

The communication apparatus 1000 may include one or more processors 1001. The processor 1001 may be a general-purpose processor or special-purpose processor, e.g., a baseband processor or a central processing unit. The baseband processor is configured to process a communication protocol as well as communication data, and the central processing unit is configured to control the communication apparatus (e.g., a base station, a baseband chip, a terminal device, a terminal device chip, a distributed unit (DU) or a centralized unit (CU)), execute a computer program, and process data in the computer program.

Optionally, the communication apparatus 1000 further includes one or more memories 1002 storing therein a computer program 1004. A computer program 1004 is executed by the memory 1002 so that the communication apparatus 1000 implements the method in the above-mentioned method embodiments. Optionally, the memory 1002 further stores therein data. The communication apparatus 1000 is arranged independent of, or integrated with, the memory 1002.

Optionally, the communication apparatus 1000 further includes a transceiver 1005 and an antenna 1006. The transceiver 1005 is also called as a transceiver unit, a transceiver machine or a transceiver circuit, and it is configured to achieve a transmission function and a reception function. The transceiver 1005 includes a receiver and a transmitter. The receiver is called as a receiving machine or a reception circuit, and it is configured to achieve the reception function. The transmitter is called as a transmitting machine or a transmission circuit, and it is configured to achieve the transmission function.

Optionally, the communication apparatus 1000 may further include one or more interface circuits 1007. The interface circuit 1007 is configured to receive a code instruction and transmit it to the processor 1001. The processor 1001 executes the code instruction, so that the communication apparatus 1000 implements the method in the above-mentioned method embodiments.

In a case that the communication apparatus 1000 is the first AI network element, the transceiver 1005 is configured to perform S31 in FIG. 3, S81 and S86 in FIG. 8, S91, S95, S97 and S99 in FIG. 9, S101, S106, S108 and S100 in FIG. 10, S111, S115 and S117 in FIG. 11, S121, S125, S128 and S120 in FIG. 12, and S131, S135, S137, S138 and S130 in FIG. 13. The processor 1001 is configured to perform S32 to S34 in FIG. 3, S41 to S42 in FIG. 4, S51 to S53 in FIG. 5, S61 and S62 in FIG. 6, S71 to S73 in FIG. 7, S82 to S85 in FIG. 8, S92 to S94 and S98 in FIG. 9, S102 to S105 and S109 in FIG. 10, S112 to S114 and S116 in FIG. 11, S122 to S124 and S129 in FIG. 12, and S132 to S134 and S139 in FIG. 13.

In a case that the communication apparatus 1000 is the AMF network element, the transceiver 1005 is configured to perform S31 in FIG. 3, S81 and S86 in FIG. 8, S91 and S99 in FIG. 9, S101 and S100 in FIG. 10, S111 and S117 in FIG. 11, S121 and S120 in FIG. 12, and S131 and S130 in FIG. 13.

In a case that the communication apparatus 1000 is the second AI network element, the transceiver 1005 is configured to perform S95 and S97 in FIG. 9, S106 and S108 in FIG. 10, S115 in FIG. 11, S125, S126 and S128 in FIG. 12, and S135, S137 and S138 in FIG. 13.

The processor 1001 is configured to perform S96 in FIG. 9, S107 in FIG. 10, S127 in FIG. 12, and S136 in FIG. 13.

In a possible embodiment of the present disclosure, the processor 1001 includes a transceiver for achieving a reception function and a transmission function. For example, the transceiver is a transceiver circuit, an interface, or an interface circuit. The transceiver circuit, the interface or the interface circuit for achieving the reception function and the transmission function may be arranged separately, or integrated with each other. The transceiver circuit, the interface or the interface circuit is configured to read and write codes/data, or transmit/or transfer signals.

In a possible embodiment of the present disclosure, the processor 1001 stores therein a computer program 1003, and the computer program 1003 is executed by the processor 1001, so that the communication apparatus 1000 implements the method in the above-mentioned method embodiments. The computer program 1003 may be programmed in the processor 1001, and in this case, the processor 1001 may be implemented through hardware.

In a possible embodiment of the present disclosure, the communication apparatus 1000 includes a circuit for implementing the transmission, reception or communication function in the above-mentioned method embodiments. The processor and the transceiver described in the embodiments of the present disclosure may be implemented in an Integrated Circuit (IC), an analog IC, a Radio Frequency IC (RFIC), a mixed-signal IC, an Application Specific Integrated Circuit (ASIC), a Printed Circuit Board (PCB) or an electronic device. The processor and the transceiver may also be manufactured through various IC processes, e.g., Complementary Metal Oxide Semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be the AMF network element, the first AI network element or the second network element, but the scope of the communication apparatus is not limited thereto. In addition, a structure of the communication apparatus is limited to that in FIG. 16. The communication apparatus may be an independent device, or a part of a large device. For example, the communication apparatus may be:
(1) an independent IC, chip, chip system or chip sub-system;
(2) a set of one or more ICs (optionally, the IC set also includes a memory member for storing therein data and a computer program;
(3) an ASIC, e.g., a Modem;
(4) a module capable of being embedded into the other device;
(5) a receiver, a terminal device, a smart terminal device, a cellular phone, a wireless device, a handheld device, a mobile unit, a vehicle-mounted device, a network device, a cloud device, an artificial intelligence device, etc.; or
(6) the other device.

In a case that the communication apparatus is a chip or a chip system, FIG. 17 is a block diagram of the chip according to an embodiment of the present disclosure.

As shown in FIG. 17, the chip 1100 includes a processor 1101 and an interface 1103. There may exist one or more processors 1101, and more than one interface 1103.

In a case that the chip is used to achieve the function of the first AI network element in the embodiments of the present disclosure, the interface 1103 is configured to receive a code instruction and transmit it to the processor. The processor 1101 is configured to execute the code instruction to implement the AI task processing method in the above-mentioned embodiments.

In a case that the chip is used to achieve the function of the AMF network element in the embodiments of the present disclosure, the interface 1103 is configured to receive a code instruction and transmit it to the processor. The processor 1101 is configured to execute the code instruction to implement the AI task processing method in the above-mentioned embodiments.

In a case that the chip is used to achieve the function of the second AI network element in the embodiments of the present disclosure, the interface 1103 is configured to receive a code instruction and transmit it to the processor. The processor 1101 is configured to execute the code instruction to implement the AI task processing method in the above-mentioned embodiments.

Optionally, the chip 1100 may further include a memory 1102 for storing therein necessary computer programs and data.

It should be appreciated that, various illustrative logical blocks and steps listed in the embodiments of the present disclosure may be implemented through electronic hardware, computer software, or a combination thereof. Whether these functions are implemented through hardware or software depends on design requirements on an entire system and specific applications. For each specific application, various methods are used to achieve the function, which however shall not be construed as going beyond the scope of the present disclosure.

The present disclosure further provides in some embodiments a readable storage medium storing therein an instruction. The instruction is executed by a computer to achieve the functions in any of the above method embodiments.

The present disclosure further provides in some embodiments a computer program product. The computer program product is executed by a computer to achieve the functions in any of the above method embodiments.

In the above-mentioned embodiments of the present disclosure, all of, or a part of, the modules are implemented in the form of software, hardware, firmware or a combination thereof. When the modules are implemented in the form of software, all of, or a part of, the modules are implemented in the form of a computer program product. The computer program product includes one or more computer programs. When the computer programs are loaded onto and executed by a computer, all of, or a part of, the processes or functions in the embodiments of the present disclosure are generated by the computer. The computer may be a general-purpose computer, a special-purpose computer, a computer network, or any other programmable device. The computer program may be stored in a computer-readable storage medium, or transferred from one computer-readable storage medium to another computer-readable storage medium, e.g., transferred from one website, one computer, one server or one data center to another website, another computer, another server or another data center in a wired manner (e.g., through a co-axial cable, an optical fiber, or a digital subscriber line (DSL)) or a wireless manner (e.g., infrared, cordless or microwave). The computer-readable storage medium may be any available medium capable of being accessed by a computer, or a data storage device, e.g., a server or a data center including one or more available mediums. The available medium may be a magnetic medium (e.g., a floppy disc, a hard disc or magnetic tape), an optical medium (e.g., a digital video disc (DVD)), or a semiconductor medium (e.g., a solid state disk (SSD)).

Unless otherwise defined, such a word “include/include” or “including/including” or any other variations involved in the specification and the appended claims intends to provide non-exclusive coverage, i.e., it means “includes, but not limited to”. Such expressions as “some embodiment” and “exemplary embodiments” involved in the specification intend to indicate that the features, structures, materials or characteristics related to the embodiments or examples are contained in at least one embodiment or example of the present disclosure, rather than referring to an identical embodiment or example. In addition, the features, structures, materials or characteristics may be combined in one or more embodiments or examples in an appropriate manner.

It should be appreciated that, such words as “first” and “second” are used to differentiate the items from each other, but shall not be construed as limiting the scope of the present disclosure or indicating any sequence.

The expression “at least one” is used to indicate one or more, e.g., two, three, four or more, which will not be particularly defined herein. In the embodiments of the present disclosure, for technical features of a same kind, the words “first”, “second”, “third”, “A”, “B”, “C” and “D” are used to differentiate these technical features, without indicating any sequence or sizes thereof. The expression “A and/or B” indicates that there is only A, there is only B, and there are both A and B.

It should be appreciated that, units and algorithm steps for instances described in the embodiments of the present disclosure may be implemented in the form of electronic hardware, or a combination of a computer program and the electronic hardware. Whether or not these functions are executed by hardware or software depends on specific applications or design constraints of the technical solution. Different methods may be adopted with respect to the specific applications so as to achieve the described functions, without departing from the scope of the present disclosure.

It should be further appreciated that, for convenience and clarification, operation procedures of the system, apparatus and units described hereinabove may refer to the corresponding procedures in the method embodiments, and thus will not be particularly defined herein.

The above embodiments are merely for illustrative purposes, but shall not be construed as limiting the scope of the present disclosure. Any person skilled in the art may make modifications and substitutions without departing from the spirit of the present disclosure, and these modifications and substitutions shall also fall within the scope of the present disclosure. Hence, the scope of the present disclosure shall be subject to the scope defined by the appended claims.

1. An artificial intelligence (AI) task processing method, executed by a first AI network element, comprising:
receiving an AI service request message sent by an access and mobility management function (AMF) network element, wherein the AI service request message is used to indicate an AI service to be provided;
determining at least one AI task based on the AI service request message;
determining a first processing parameter of the first AI network element and a second processing parameter of a second AI network element; and
determining at least one of a first task to be executed by the first AI network element or a second task to be executed by the second AI network element in the at least one AI task based on the at least one AI task, the first processing parameter and the second processing parameter.

2. The AI task processing method according to claim 1, wherein the determining at least one of the first task to be executed by the first AI network element or the second task to be executed by the second AI network element in the at least one AI task based on the at least one AI task, the first processing parameter and the second processing parameter comprises:
determining at least one target task type of the at least one AI task; and
determining at least one of the first task to be executed by the first AI network element or the second task to be executed by the second AI network element in the at least one AI task based on the at least one target task type, the first processing parameter and the second processing parameter, wherein the first processing parameter comprises a first task type supported to be processed by the first AI network element, and the second processing parameter comprises a second task type supported to be processed by the second AI network element.

3. The AI task processing method according to claim 1, wherein
the AI service request message is further used to indicate a time threshold for obtaining a processing result, wherein the determining at least one of the first task to be executed by the first AI network element or the second task to be executed by the second AI network element in the at least one AI task based on the at least one AI task, the first processing parameter and the second processing parameter comprises:
determining a first duration for obtaining a first processing result based on the at least one AI task and the first processing parameter, wherein the first processing result is obtained via processing, by the first AI network element, the first task;
determining a second duration for obtaining a second processing result based on the at least one AI task and the second processing parameter, wherein the second processing result is obtained via processing, by the second AI network element, the second task; and
determining at least one of the first task to be executed by the first AI network element or the second task to be executed by the second AI network element in the at least one AI task based on the time threshold, the first duration and the second duration.

4. The AI task processing method according to claim 3, wherein the determining at least one of the first task to be executed by the first AI network element or the second task to be executed by the second AI network element based on the time threshold, the first duration and the second duration comprises at least one of:
in response to meeting t_{0,k}≤Tₘₐₓ, determining that a k^{th} AI task is to be executed by the first AI network element; or
in response to meeting
$${t}_{i , k}^{comp} + {t}_{i , k}^{up} \leq {T}_{max} ,$$
determining that the k^{th} AI task is to be executed by an i^{th} second AI network element,
wherein Tₘₐₓ represents the time threshold;
t_{0,k} represents the first duration for processing, by the first AI network element, the k^{th} AI task,
$${t}_{0 , k} = \frac{{D}_{k}}{{r}_{0 , k}} ,$$
Dₖ represents a data volume of the k^{th} AI task, and r_{0,k} represents a computing rate at which the k^{th} AI task is processed by the first AI network element;
$${t}_{i , k}^{comp} + {t}_{i , k}^{up}$$
represents the second duration for processing, by the i^{th} second AI network element, the k^{th} AI task;
$${t}_{i , k}^{comp}$$
represents a computing time for processing, by the i^{th} second AI network element, the k^{th} AI task;
$${t}_{i , k}^{comp} = {t}_{i , k} + {T}_{i , k} , {t}_{i , k} = \frac{{D}_{k}}{{r}_{i , k}^{comp}} , {r}_{i , k}^{comp}$$
represents a computing rate at which the k^{th} AI task is processed by the i^{th} second AI network element, and T_{i,k} represents a waiting delay;
$${t}_{i , k}^{up}$$
represents an uploading time for uploading, by the i^{th} second AI network element, a processing result of the k^{th} AI task; and
$${t}_{i , k}^{up} = \frac{{D}_{k}}{{r}_{i , k}^{up}} , and {r}_{i , k}^{up}$$
represents an uploading rate at which the processing result of the k^{th} AI task is uploaded by the i^{th} second AI network element;
wherein i and k are both integers.

5. The AI task processing method according to claim 4, wherein the determining the first processing parameter of the first AI network element comprises:
determining the computing rate r_{0,k} at which the k^{th} AI task is processed by the first AI network element;
wherein
$${r}_{0 , k} = \frac{{f}_{0} {t}_{0 , k}}{M {t}_{0 , k}} = \frac{{f}_{0}}{M} ,$$
f₀ represents a computing frequency of the first AI network element, and M represents a central processing unit (CPU) cycle number for processing, by the first AI network element, 1-bit task data; and
wherein the determining the second processing parameter of the second AI network element comprises:
determining the computing rate
$${r}_{i , k}^{comp}$$
at which the k^{th} AI task is processed by the i^{th} second AI network element, the uploading rate
$${r}_{i , k}^{up}$$
at which the processing result of the k^{th} AI task is uploaded, and the waiting relay T_{i,k};
wherein
$${r}_{i , k}^{comp} = \frac{{f}_{i} {t}_{i , k}}{{M}_{i} {t}_{i , k}} = \frac{{f}_{i}}{{M}_{i}} , {r}_{i , k}^{up} = B log ( 1 + \frac{{Ph}_{i}^{2}}{{N}_{0}} ) ,$$
B represents a bandwidth, P represents power, N₀ represents a gaussian white noise, hᵢ represents a wireless channel gain between the i^{th} second AI network element and the first AI network element, fᵢ represents a computing frequency of the i^{th} second AI network element, and Mᵢ represents a CPU cycle number for processing, by the i^{th} second AI network element, 1-bit task data.

6. (canceled)

7. The AI task processing method according to claim 1, wherein the determining at least one of the first task to be executed by the first AI network element or the second task to be executed by the second AI network element in the at least one AI task based on the at least one AI task, the first processing parameter and the second processing parameter comprises:
determining a task offloading policy generation model; and
inputting the computing frequency of the first AI network element, the computing frequency of the second AI network element and the wireless channel gain between the second AI network element and the first AI network into the task offloading policy generation model to generate a target task offloading policy, wherein the target task offloading policy comprises at least one of the first task to be executed by the first AI network element or the second task to be executed by the second AI network element in the at least one AI task, the first processing parameter comprises the computing frequency of the first AI network element, and the second processing parameter comprises the computing frequency of the second AI network element and the wireless channel gain between the second AI network element and the first AI network element.

8. The AI task processing method according to claim 7, wherein the determining the task offloading policy generation model comprises:
initializing a model parameter, and determining an initial task offloading policy generation model;
determining a first initial computing frequency of the first AI network element, a second initial computing frequency of the second AI network element, and an initial wireless channel gain between the second AI network element and the first AI network element; and
performing joint training on the initial task offloading policy generation model, at least one of a first initial local model for the first AI network element or a second initial local model for the second AI network element based on the first initial computing frequency, the second initial computing frequency and the initial wireless channel gain, to generate the task offloading policy generation model and at least one of a first local model for the first AI network element or a second local model for the second AI network element.

9. The AI task processing method according to claim 8, wherein the performing the joint training on the initial task offloading policy generation model, at least one of the first initial local model for the first AI network element or the second initial local model for the second AI network element based on the first initial computing frequency, the second initial computing frequency and the initial wireless channel gain comprises:
determining iteration epochs T, where T is a positive integer;
determining that input model data for a first epoch comprises the first initial computing frequency, the second initial computing frequency and the initial wireless channel gain;
determining that input model data for a t^{th} epoch comprises at least one of an updated computing frequency of the first AI network element or an updated computing frequency of the second AI network element for a (t−1)^{th} epoch and the initial wireless channel gain which are determined after at least one of the first initial local model for the first AI network element or the second initial local model for the second AI network element are updated based on input model data for the (t−1)^{th} epoch, where 2≤t≤T;
sequentially performing joint training on the initial task offloading policy generation model, at least one of the first initial local model for the first AI network element or the second initial local model for the second AI network element based on input model data for each epoch; and
generating the task offloading policy generation model, at least one of the first local model for the first AI network element or the second local model for the second AI network element until the joint training is performed on the initial task offloading policy generation model, at least one of the first initial local model for the first AI network element or the second initial local model for the second AI network element based on input model data for a T^{th} epoch.

10. The AI task processing method according to claim 9, wherein the performing the joint training on the initial task offloading policy generation model, at least one of the first initial local model for the first AI network element or the second initial local model for the second AI network element based on the input model data for the first epoch comprises:
inputting the first initial computing frequency, the second initial computing frequency and the initial wireless channel gain into the initial task offloading policy generation model to generate an initial task offloading policy, wherein the initial task offloading policy comprises at least one of an initial AI task to be executed by the first AI network element or an initial AI task to be executed by the second AI network element;
determining a processing result of at least one of the initial AI task executed by the first AI network element or the initial AI task executed by the second AI network element, and generating a model updating parameter, wherein the model updating parameter comprises at least one of an updating parameter of the first AI network element or an updating parameter of the second AI network element;
in response to the model updating parameter comprising a first updating parameter of the first AI network element, updating at least one of the initial task offloading policy generation model or the first initial local model for the first AI network element based on the first updating parameter; and
in response to the model updating parameter comprising a second updating parameter of the second AI network element, distributing the second updating parameter to the second AI network element.

11. The AI task processing method according to claim 1, further comprising:
executing the first task in response to determining the first task to be executed by the first AI network element to generate a first processing result; and
sending the first processing result to the AMF network element.

12. The AI task processing method according to claim 11, wherein the executing the first task in response to determining the first task to be executed by the first AI network element to generate the first processing result comprises:
in response to determining the first task to be executed by the first AI network element, receiving a first data set sent by a network function (NF) network element; and
executing the first task based on the first data set to generate the first processing result.

13. (canceled)

14. The AI task processing method according to claim 1, further comprising:
in response to determining the second task to be executed by the second AI network element, sending the second task to the second AI network element;
receiving a preliminary processing result sent by the second AI network element, wherein the preliminary processing result is generated via executing, by the second AI network element, the second task, and
sending a response message to the second AI network element, wherein the response message is used to indicate that the first AI network element has received the preliminary processing result.

15. (canceled)

16. The AI task processing method according to claim 14, further comprising at least one of:
sending the second processing result to the AMF network element, wherein the second processing result is determined by the first AI network element based on the preliminary processing result, or
in response to determining the first processing result and the preliminary processing result, processing the first processing result and the preliminary processing result to generate a target processing result, and sending the target processing result to the AMF network element.

17-18. (canceled)

19. An AI task processing method, executed by an AMF network element, comprising:
receiving an AI service establishment request message sent by a terminal device, wherein the AI service establishment request message is used to indicate an AI service required by the terminal device; and
sending an AI service request message to a first AI network element, wherein the AI service request message is used to indicate the AI service to be provided, and the first AI network element determines at least one AI task, a first processing parameter of the first AI network element and a second processing parameter of a second AI network element based on the AI service request message, and determines at least one of a first task to be executed by the first AI network element or a second task to be executed by the second AI network element in the at least one AI task based on the at least one AI task, the first processing parameter and the second processing parameter.

20. The AI task processing method according to claim 19, further comprising at least one of:
receiving a first processing result sent by the first AI network element, wherein the first processing result is generated via executing, by the first AI network element, the first task;
receiving a second processing result sent by the first AI network element, wherein the second processing result is determined by the first AI network element based on a preliminary processing result, and the preliminary processing result is generated via executing, by the second AI network element, the second task; or
receiving a target processing result sent by the first AI network element, wherein the target processing result is generated via processing, by the first AI network element, a first processing result and a preliminary processing result in a case of determining the first processing result and the preliminary processing result, the first processing result is generated via executing, by the first AI network element, the first task, and the preliminary processing result is generated via executing, by the second AI network element, the second task.

21-22. (canceled)

23. An AI task processing method, executed by a second AI network element, comprising:
receiving a second task sent by a first AI network element, wherein the second task is determined by the first AI network element to be executed by the second AI network element based on at least one AI task, a determined first processing parameter of the first AI network element and a determined second processing parameter of the second AI network element, and sent by the first AI network element to the second AI network element, the at least one AI task is determined by the first AI network element based on an AI service request message sent by an AMF network element, and the AI service request message is used to indicate an AI service to be provided.

24. The AI task processing method according to claim 23, further comprising at least one of:
executing the second task to generate a preliminary processing result: or
receiving a second updating parameter sent by the first AI network element, and updating an initial local model for the second AI network element based on the second updating parameter.

25. The AI task processing method according to claim 24, wherein the executing the second task to generate the preliminary processing result comprises:
receiving a second data set sent by a NF network element; and
executing the second task based on the second data set to generate the preliminary processing result.

26. (canceled)

27. The AI task processing method according to claim 24, further comprising:
sending the preliminary processing result to the first AI network element, and
receiving a response message sent by the first AI network element, wherein the response message is used to indicate that the first AI network element has received the preliminary processing result.

28-31. (canceled)

32. A communication apparatus, comprising a processor and a memory, wherein the memory is configured to store therein a computer program, and the processor is configured to execute the computer program in the memory to implement the AI task processing method according to claim 1.

33-35. (canceled)
